(19) United States
(12) Patent Application Publication
(10) Pub. No.: US 2026/0080217 A1
(43) Pub. Date: Mar. 19, 2026

(54) KEY-VALUE CACHE COMPRESSION BASED ON GAUGE TRANSFORMATION

(71) Applicant: Intel Corporation, Santa Clara, CA (US)

(72) Inventor: Hong Wang, Santa Clara, CA (US)

(73) Assignee: Intel Corporation, Santa Clara, CA (US)

(21) Appl. No.: 19/396,765

(22) Filed: Nov. 21, 2025

Related U.S. Application Data
(60) Provisional application No. 63/878,398, filed on Sep. 9, 2025.

(51) Int. Cl. G06N 3/0455; G06N 3/0495

(52) U.S. Cl. CPC G06N 3/0455; G06N 3/0495

(57) ABSTRACT

KV cache for transformer models may be compressed through gauge transformation, entropy encoding, or rank-r approximation. Transformation matrices may be determined for gauge transformation of an attention layer. The query weight matrix and key weight matrix of the head may be transformed using a transformation matrix. The value weight matrix and output weight matrix of the head may be transformed using another transformation matrix. The gauge transformation may produce canonicalized weights. The attention layer may be updated with the canonicalized weights. The canonicalized model may be executed, and canonicalized KV data may be produced during the execution. A portion of the canonicalized KV data may be further compressed entropy encoding and then stored in a cold tail cache. The rest of the canonicalized KV data may be stored in a hot window cache. The canonicalized KV data may be further compressed based on rank-r approximation before or after gauge transformation.

### CROSS-REFERENCE TO RELATED APPLICATION

This application claims the benefit of U.S. Provisional Patent Application No. 63/878,398, filed Sep. 9, 2025, and entitled “COMPOSABLE EXACT KEY-VALUE CACHE COMPRESSION,” which is incorporated by reference in its entirety.

### TECHNICAL FIELD

This disclosure relates generally to neural network (also referred to as “deep neural network” or “DNN”), and more specifically, key-value (KV) cache compression based on gauge transformation.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 illustrates an example transformer model, in accordance with various embodiments.

FIG. 2 illustrates an example embedding layer, in accordance with various embodiments.

FIG. 3 illustrates positional encoding, in accordance with various embodiments.

FIGS. 4A and 4B illustrate an example multi-head attention (MHA) layer, in accordance with various embodiments.

FIG. 5 illustrates an example linear classifier, in accordance with various embodiments.

FIG. 6 illustrates a first inference stage of a transformer model, in accordance with various embodiments.

FIG. 7 illustrates subsequent inference stages of the transformer model, in accordance with various embodiments.

FIG. 8 illustrates computations in a self-attention layer without KV caching, in accordance with various embodiments.

FIG. 9 illustrates computations in a self-attention layer with KV caching, in accordance with various embodiments.

FIG. 10 is a block diagram of an AI system, in accordance with various embodiments.

FIG. 11 is a block diagram of an AI accelerator, in accordance with various embodiments.

FIG. 12 illustrates a dataflow in an attention layer 1200 without weight canonicalization, in accordance with various embodiments.

FIG. 13 illustrates a process of canonicalizing an attention layer, in accordance with various embodiments.

FIG. 14 illustrates a runtime operation with compressed KV cache, in accordance with various embodiments.

FIG. 15 is a flowchart of a method for executing a transformer model, in accordance with various embodiments.

FIG. 16 is a block diagram of an example computing device, in accordance with various embodiments.

### DETAILED DESCRIPTION

The last decade has witnessed a rapid rise in AI based data processing, particularly based on neural networks (also referred to as deep neural networks (DNNs)). DNNs are widely used in various domains (e.g., language processing, computer vision, speech recognition, autonomous driving, image processing, video processing, etc.) mainly due to their ability to achieve beyond human-level accuracy. A DNN typically includes a sequence of layers. A DNN layer may include one or more deep learning operations (also referred to as “neural network operations”), such as embedding operation, MatMul operation, layer normalization, batch normalization, activator operations (e.g., Sigmoid linear unit (SiLU) operation, SoftMax operation, etc.), pooling, elementwise operation, linear operation, nonlinear operation, and so on.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), 3D tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L−1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

Due to incompressibility of KV cache states in transformer models, KV cache has emerged as the primary memory bottleneck in large language model serving, fundamentally limiting deployment scalability and context lengths. During autoregressive generation, each token can produce key and value vectors that need to be stored for attending to all future tokens, creating a memory footprint that scales linearly with sequence length and prevents practical deployment of long-context models. The cache entries appear as dense, high-dimensional vectors with full-rank covariance matrices, making traditional compression techniques ineffective. For a model serving sequences of length T with L layers and d-dimensional representations, the KV cache can consume 0 (LTd) memory per sequence, which can frow linearly with context length and dominates video random access memory (VRAM) usage in production systems. Consider a 70-byte (B) parameter model serving 128K context, the KV cache alone can require over 70 GB of memory per request at FP16 precision, making it impossible to serve multiple concurrent users on even the largest graphics processing units (GPUs). This memory pressure can directly translate to reduced batch sizes, lower throughput, and increased serving costs. For instance, a single A100 GPU costing $15,000 can serve one or two long-context requests simultaneously due to KV memory constraints.

Currently available approaches to KV cache compression fall into three categories, each with fundamental limitations. First, architectural modifications like grouped-query attention (GQA) and multi-query attention (MQA) can reduce the number of KV heads but require training new models from scratch, making them inapplicable to the vast ecosystem of already-deployed models. Second, eviction-based methods, including H2O, SnapKV, and StreamingLLM, can selectively retain “important” tokens, but inherently sacrifice accuracy by discarding information, leading to unpredictable degradation on downstream tasks. Third, quantization approaches, such as KIVI and KVQuant, can reduce precision per scalar but face diminishing returns below 4-bit representations and still require careful calibration to avoid quality loss. Notably, none of these methods can provide formal guarantees about output preservation or error bounds, making them risky for production deployment where reliability is paramount. These approaches either require model retraining, sacrifice output quality through lossy approximation, or provide only marginal improvements.

A fundamental challenge in KV compression is that the cache entries appear to be incompressible dense activations with no obvious structure to exploit. Standard compression techniques fail because keys and values are high-dimensional vectors with full-rank covariance matrices, and naive basis changes or projections destroy the attention mechanism's output. This can lead to a perceived tradeoff between memory efficiency and model quality, where practitioners need to choose between serving fewer users with full quality or more users with degraded outputs.

Embodiments of this disclosure may improve on at least some of the challenges and issues described above by providing GaugeKV, a KV cache compression technique based on gauge transformation. The KV cache compression technique may be a composable exact compression technique. Gauge transformation of a machine learning model may reparamerterize model weights or data representations while preserving the model's outputs. For example, gauge transformation of a machine learning model can produce bit-identical outputs and preserve the exact model function. Gauge transformation may be combined with KV compression through entropy encoding or rank-r projection. Entropy encoding can further compress KV data for older context. Rank-r approximation mode can provide controlled accuracy-memory tradeoffs with mathematical guarantees. The KV cache compression approach in this disclosure can achieve exact preservation of model function, compression effectiveness, and bound compliance.

In various embodiments of this disclosure, KV data of transformer models may be compressed using gauge canonicalization, entropy encoding, rank-r projection, or some combination thereof. For gauge transformation, a transformation matrix for the query-key space and a transformation matrix for the value space may be determined for a head of an attention layer. The query weight matrix and key weight matrix of the head may be transformed using the transformation matrix for the query-key space. The value weight matrix and output weight matrix of the head may be transformed using the transformation matrix for the value space. The gauge transformation of the wight matrices produces canonicalized weights. The head of the attention layer may be updated with the canonicalized weights. Other heads of the attention layer may also be updated with canonicalized weights computed based on transformation matrices for these heads. The other attention layers of the transformer model may also be canonicalized in the same or similar manner. The gauge transformation may be performed in FP32 precision. FP stands for floating-point. The canonicalized model may be executed, and canonicalized KV data may be produced during the execution. The canonicalized KV data may be further compressed. The canonicalized KV data may be stored in a hot window cache and a cold tail cache. The hot window cache may store canonicalized keys and values that correspond to hot window tokens. The hot window tokens may be tokens inside a sliding hot window with a predetermined length W. The hot window may include W recent tokens. The hot window may slide over a token after each stage of the inference process. The cold tail cache may store canonicalized keys and values that are further compressed through entropy encoding. The canonicalized keys and values in the cold tail cache may correspond to the tokens outside the hot window, which may be older tokens. The hot window cache may be faster than the cold tail cache. The canonicalized KV data may be further compressed based on rank-r approximation. Rank-r approximation may reduce a dimension of the key weight matrix or a dimension of the value weight matrix so that a dimension of the query matrix and value matrix may also be reduced. The rank-r approximation may be performed before or after gauge transformation.

GaugeKV can solve the technical problem related to incompressibility of KV cache states in transformer models by leveraging that the attention mechanism typically possesses a hidden gauge symmetry that allows specific coordinate transformations while preserving the model's function exactly. This symmetry typically arises from the fact that attention involves two separate matrix products: one for computing attention weights through query-key interactions, and another for mixing values. By applying inverse transformations at these interaction points, GaugeKV can change the internal representation while maintaining identical outputs. GaugeKV can choose these transformations to create naturally compressible representations rather than arbitrary basis changes.

GaugeKV can fundamentally change the economics of large language model deployment by enabling existing models to serve longer (e.g., 4-10× longer) contexts or more concurrent users on the same hardware through a one-time gauge transformation, directly reducing infrastructure costs and democratizing access to long-context AI capabilities. The method can provide mathematically guaranteed bounds for KV cache compression, transforming approximate caching from a risky heuristic into a certifiable technique suitable for production systems where reliability and predictability are paramount. Furthermore, GaugeKV can work as a drop-in enhancement for the entire ecosystem of already-deployed transformer models without requiring any retraining, immediately benefiting billions of dollars' worth of existing AI infrastructure and accelerating the deployment of context-intensive applications like multi-document reasoning, code analysis, and long-form content generation that were previously prohibitively expensive to serve at scale.

GaugeKV can also provide opportunities for hardware-level optimizations that could significantly enhance performance and efficiency beyond pure software implementation. These optimizations may span from better utilization of existing hardware features to potential custom accelerator designs that could make gauge-based compression a first-class hardware primitive. The orthonormal structure of canonicalized values can create highly predictable memory access patterns that could benefit from specialized prefetching strategies. Since the energy concentration in leading coordinates follows a monotonic decrease, hardware prefetchers could be programmed with this knowledge to anticipate which cache lines would be needed for rank-r operations, reducing memory latency during the value projection phase. The block-structured nature of the compressed cold cache can align naturally with GPU texture memory and compression hardware originally designed for graphics workloads. Hardware compression engines can be repurposed for entropy coding of canonicalized KV blocks. The fixed block size B used in GaugeKV may match the granularity of these hardware compression units, potentially enabling compression and decompression to occur entirely in hardware without central processing unit (CPU) intervention. This can eliminate the current software overhead of entropy coding and make the compression essentially free from a computational perspective. The regularity of gauge transformations can make them ideal candidates for dedicated hardware acceleration.

Gauge canonicalization can create predictable memory access patterns and enable several memory system optimizations. The orthonormal basis can ensure that accessing the first r coordinates of a value vector require reading a contiguous block of memory, eliminating the scattered access patterns that typically plague sparse approximation methods. This contiguity could be exploited through specialized memory controllers that prefetch entire rank-r blocks in single transactions, reducing memory bandwidth requirements and improving cache utilization. The balanced scales achieved in the key space through geometric mean transformation can create uniform dynamic ranges across different attention heads, enabling more efficient use of memory bandwidth. Hardware could implement adaptive bit-width allocation where all keys within a certain range can share the same exponent, similar to block floating-point representations, but optimized for the specific distribution created by gauge canonicalization. This would provide additional compression beyond what entropy coding alone achieves while maintaining the mathematical guarantees of the approach. High-bandwidth memory architectures could be redesigned to better support the two-tier caching strategy. The hot window could reside in fast on-chip static random-access memory (SRAM) cache or high-bandwidth memory (HBM) cache, while the compressed cold tail could use slower but denser memory technologies. The hardware can implement intelligent migration policies that move blocks between tiers based on access patterns, potentially predicting which historical tokens would be accessed based on attention patterns observed during training.

The compression and decompression operations can be performed directly in memory modules equipped with near-data processing capabilities, eliminating the need to move compressed data to compute units for decoding. This can be especially beneficial for the cold cache, where blocks are accessed infrequently but need to be decompressed quickly when needed. Neuromorphic and analog computing elements can potentially accelerate the approximate projection operations in the rank-r mode. The smooth energy decay in the canonical basis suggests that analog circuits can implement approximate projections with very low power consumption, using the natural noise characteristics of analog computation to provide automatic regularization that stays within the proven bounds. Quantum computing architectures can also potentially accelerate the matrix decomposition operations required for canonicalization. The geometric mean computation, in particular, involves eigende composition operations that quantum algorithms can accelerate, potentially making real-time re-canonicalization feasible for adaptive compression schemes.

Matrix multiplication units in many AI accelerators can be optimized for the specific patterns that emerge from gauge canonicalization. The sparse structure that develops in canonicalized values, where later coordinates have progressively smaller magnitudes, suggests that dynamic precision allocation can be highly effective. Tensor cores can adaptively reduce precision for trailing coordinates while maintaining full precision for leading ones, achieving additional compression without explicit quantization steps. The economic implications of hardware-accelerated GaugeKV can be substantial. By reducing the memory footprint of KV cache by 4-10× in typical deployments, each accelerator can serve proportionally more users, directly improving the return on investment for expensive AI hardware. The deterministic nature of the compression ratios can also enable more predictable capacity planning, reducing the overprovisioning typically required to handle variable workloads. Organizations deploying large-scale inference services could achieve the same throughput with fewer accelerators or serve significantly longer contexts with their existing hardware fleet.

The compression benefits compose multiplicatively with other memory optimizations because the gauge transformation operates at a fundamentally different level than architectural or quantization approaches. While GQA can reduce the number of KV heads, quantization can reduce bits per scalar, and token eviction can reduce sequence length, GaugeKV can improve the compressibility of whatever data remains. This orthogonality can ensure that GaugeKV can be deployed on top of existing optimization techniques to achieve additional memory savings without modifying their current serving architecture.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

FIG. 1 illustrates an example transformer model 100, in accordance with various embodiments. The transformer model 100 may transform input sequences into output sequences. In some embodiments, the transformer model 100 is a DNN that can learn context and meaning by tracking relationships in sequential data, such as sequential words in a sentence, sequential audio signals, sequential images, and so on. In an example, the transformer model 100 may be an LLM. The transformer model 100 includes an encoder block 110, a decoder block 120, and a head block 130. In other embodiment, different or additional components may be included in the transformer model 100. Further, functionality attributed to a component of the transformer model 100 may be accomplished by a different component included in the transformer model 100 or a different model or module.

The encoder block 110 receives input sequences and generates matrix representations of the input sequences. In the embodiments of FIG. 1, the encoder block 110 receives an input 101 and generates an encoder output 102. The input 101 may be an input prompt. In some embodiments, the input 101 may include one or more input tokens, such as words, phrases, sentences, images, audio signals, other types of input tokens, or some combination thereof. In an example, the input 101 may include a prompt received from a user of the transformer model 100. The prompt may include a question or request made by the user. A word in the prompt may be an input token. The encoder output 102 may include one or more vectors that are contextualized representations of the input 101. Each vector in the encoder output 102 may represent a token in the input 101 with contextual understanding.

The encoder block 110 includes an embedding layer 113, a positional encoding layer 115, and a plurality of layers 140 (individually referred to as “layer 140”). In other embodiments, the encoder block 110 may have different, fewer, or more components. Also, the arrangement of the components in the encoder block 110 may be different from the arrangement shown in FIG. 1. For the purpose of illustration, the encoder block 110 has N layers in FIG. 1, where N is an integer. Each layer 140 may include one or more neural network operations. The layers 140 may transform a sequence of embeddings into a representation that encapsulates the learned information from the input 101. Different layers 140 may have different internal parameters, e.g., different weights, bias, or other types of internal parameters. In some embodiments, the layers 140 have identical components. The components in a layer 140 may be layers and may also be referred to as sub-layers of the layer 140. As shown in FIG. 1, a layer 140 includes four sub-layers: an MHA layer 141, an add & norm layer 142, a feed forward layer 143, and another add & norm layer 144.

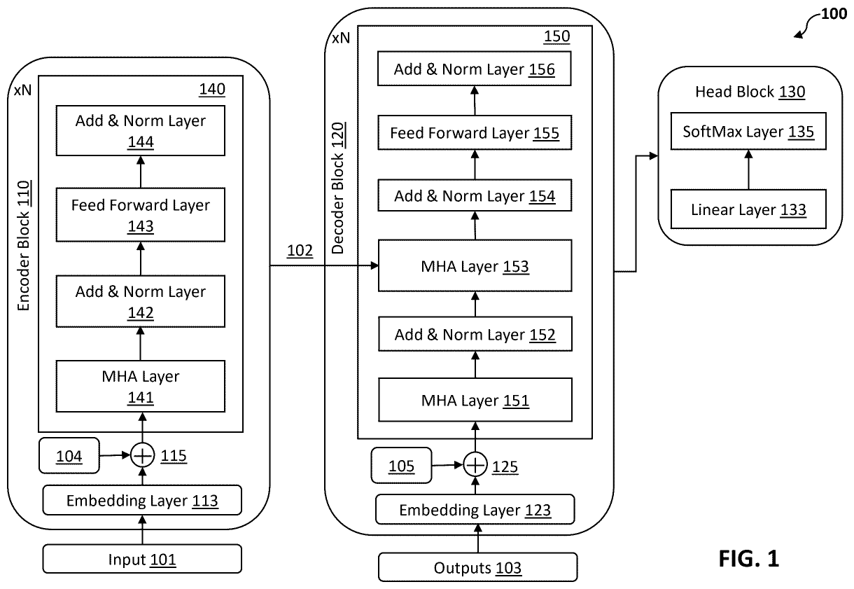

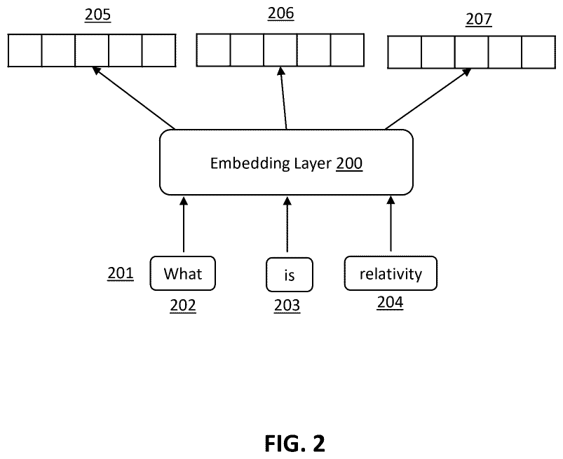

The decoder block 120 iteratively generates outputs 103 using encoded representations generated by the encoder block 110. The decoder block 120 includes an embedding layer 123, a positional encoding layer 125, and a plurality of layers 150 (individually referred to as “layer 150”). For illustration, the decoder block 120 has N layers in FIG. 1, where N is an integer. In the embodiments of FIG. 2, the number of layers 150 in the decoder block 120 is the same as the number of layers 140 in the encoder block 110. In other embodiments, the number of layers 150 in the decoder block 120 may be different from the number of layers 140 in the encoder block 110. Each layer 150 may include one or more neural network operations. Different layers 150 may have different internal parameters. In some embodiments, the layers 150 may have identical components. The components in a layer 150 may be layers and may also be referred to as sub-layers of the layer 150. As shown in FIG. 1, a layer 150 includes six sub-layers: an MHA layer 151, an add & norm layer 152, an encoder-decoder attention layer 153, another add & norm layer 154, a feed forward layer 155, and another add & norm layer 156.

In some embodiments, a sequence of inference stages is performed in the decoder block 120 using encoder outputs, e.g., the encoder output 102. A matrix may be predicted through each inference stage. The outputs 103 may include a plurality of matrices. Each matrix may be further processed in the head block 130 to predict a token. The plurality of matrices may be used to predict a sequence of tokens. For the first inference stage, the decoder block 120 may receive one or more start tokens as input tokens and compute a first matrix from the input tokens and the output of the encoder block 110. The first matrix may be used by the head block 130 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 130 receives the output of the decoder block 120 and processes it in a linear layer 133 and a SoftMax layer 135. A linear operation may be performed on the output of the decoder block 120 in the linear layer 133. The linear operation may include a multiplication of the output of the decoder block 120 with a weight matrix. The output of the linear layer 133 may be a vector. In some embodiments, the head block 130 may function as a classifier. The number of data elements in the vector computed in the linear layer 133 may depend on the number of classes involved. In an example where there are M classes, where M is an integer, the vector computed in the linear layer 133 may have M data elements representing the prediction for the M classes, respectively.

The output of the linear layer 133 may be input into the SoftMax layer 135. A SoftMax function may be applied on the output of the linear layer 133 to compute probability scores. A probability score may have a value in the range from 0 to 1. In some embodiments, a probability value is computed for each data element in the vector computed in the linear layer 133. The highest one of the probability scores may be the key. The corresponding index of the key may point to the token that the transformer model 100 predicts as the next in the sequence. The final output of the transformer model 100 may be the sequence of predicted tokens. In some embodiments, the head block 130 may be a language modeling head.

An embedding layer (e.g., the embedding layer 113 or the embedding layer 123) converts an input of the embedding layer (e.g., the input 101 or the outputs 103) into one or more embeddings. An embedding may be a vector, which is also referred to as an embedding vector or a vector embedding. The vector embedding may include a sequence of data elements. In some embodiments, the embedding layer 113 may generate a plurality of embeddings, each of which may be converted from a different input token in the input 101. The embeddings may capture the semantic meaning of the tokens in the input 101. The embeddings may be numerical representations that capture the relationships or meanings of words, phrases, or other data types. In an example where the input 101 is a prompt including a sequence of words, the embedding layer 113 may generate an embedding from each word in the input 101. The embedding layer 123 in the decoder block 120 may generate a plurality of embeddings from tokens received by the decoder block 120 in a similar manner as the embedding layer 113. Certain aspects of embedding layers are described below in conjunction with FIG. 2.

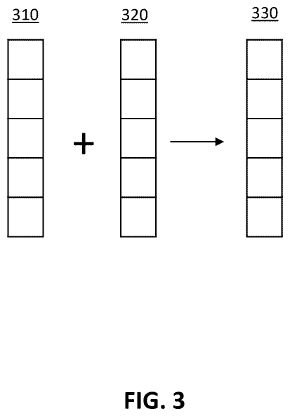

A positional encoding layer (e.g., the positional encoding layer 115 or the positional encoding layer 125) performs positional encoding on embeddings generated in the corresponding embedding layer. In some embodiments, the positional encoding layer may apply one or more positional encoding vectors (e.g., a positional encoding vector 104 or positional encoding vector 105) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer. Certain aspects of positional encoding layers are described below in conjunction with FIG. 3.

An MHA layer (e.g., the MHA layer 141, the MHA layer 151, or the MHA layer 153) may implement a multi-head attention mechanism, which may be a multi-head self-attention mechanism or a multi-head cross-attention mechanism. In some embodiments, the MHA layer 141 or the MHA layer 151 may implement a self-attention mechanism. For self-attention, the queries, keys, and values may come from the same place. For instance, for the MHA layer 141, the queries, keys, and values may all come from the positional encoding layer 115. For the MHA layer 151, the queries, keys, and values may all come from the positional encoding layer 125. The self-attention mechanism may enable the transformer model 100 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 141 may be computed from vector embeddings generated by the positional encoding layer 115. The queries, keys, and values input into the MHA layer 151 may be computed from vector embeddings generated by the positional encoding layer 125. A query, key, or value may be a vector the represents a token in a sequence. In some embodiments, a query matrix Q∈ [symbol] ^{N×h} may be computed by multiply an embedding matrix X∈ [symbol] ^{N×d} (e.g., an embedding matrix computed in a positional encoding layer) with a weight matrix W_{q}∈ [symbol] ^{d×h}, where d is the dimension of a vector embedding, N is the number of vector embeddings in the embedding matrix, and h is the number of attention heads. Each row in the query matrix may be a query. A key matrix K∈ [symbol] ^{N×h} may be computed by multiple an embedding matrix X∈ [symbol] ^{N×d} (e.g., an embedding matrix computed in a positional encoding layer) with a weight matrix Wₖ∈ [symbol] ^{d×h} Each row in the key matrix may be a key. A value matrix V∈ [symbol] ^{N×h} may be computed by multiple an embedding matrix X∈ [symbol] ^{N×d} (e.g., an embedding matrix computed in a positional encoding layer) with a weight matrix Wᵥ∈ [symbol] ^{d×h}. Each row in the value matrix may be a value.

In some embodiments, the MHA layer 151 may implement masked multi-head self-attention. The MHA layer 151 may prevent positions from attending to subsequent positions. For instance, each token in the sequence may not be influenced by future tokens. This masking can ensure that the predictions of a particular position can depend on known outputs at positions before it and not depend on unknown outputs at positions after it.

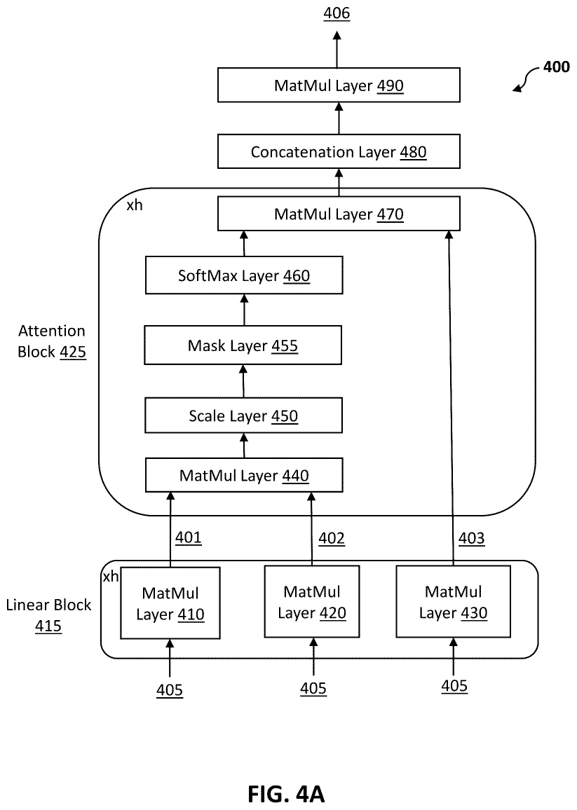

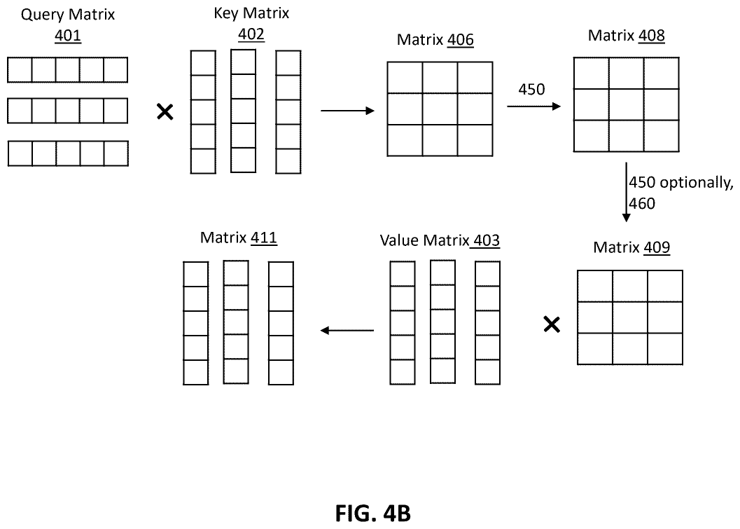

In some embodiments, the MHA layer 153 may implement a cross-attention mechanism, such as encoder-decoder cross-attention. The MHA layer 153 may use outputs from the previous layer (i.e., the add & norm layer 152) as queries and use outputs from the encoder block 110 as keys and values. The cross-attention can align the encoder's input with the decoder's, empowering the decoder block 120 to identify and emphasize the most relevant parts of the encoder's input. Certain aspects of MHA layers are described below in conjunction with FIGS. 4A and 4B.

An add & norm layer in the transformer model 100, such as the add & norm layer 142, 144, 152, 154, and 156, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 142 is the MHA layer 141. As another example, the preceding layer of the add & norm layer 154 is the encoder-decoder attention layer 153.

Then the layer normalization operation is applied on the result of the addition operation, which may be denoted as LayerNorm(x+sublayer(x)), where LayerNorm denotes layer normalization, x is the input of the preceding layer, and sublayer(x) denotes the output of the preceding layer. In some embodiments, the layer normalization operation may include a sequence of computations. In an example, the layer normalization operation may include a mean computation, which may be denoted as

$${μ}_{xy} = \frac{1}{z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${σ}_{xy}^{2} = {\sum }_{z = 1}^{Z} {D}_{xyz}^{2}$$

and a division computation denoted as

$${M}_{xy} = \frac{1}{\sqrt{\frac{1}{Z} \times ( {σ}_{xy}^{2} + ϵ \times Z )}} . {M}_{xy}$$

may be a 2D tensor. The layer normalization operation may also convert M_{xy} to a 3D tensor M_{xyz}, e.g., by replicating every data element over z output points. Further, the layer normalization operation may have an element multiplication denoted as

$${A}_{xyz}^{′} = \frac{{A}_{xyz} - {μ}_{xyz}}{\sqrt{\frac{1}{Z} \times ( {σ}_{xy}^{2} + ϵ )}} = ( {A}_{xyz} - {μ}_{xyz} ) \times \frac{1}{\sqrt{\frac{1}{Z} \times ( {σ}_{xy}^{2} + ϵ )}} {D}_{xyz} \times {M}_{xyz} .$$

The layer normalization operation may further compute

$${A}_{xyz}^{″} = {A}_{xyz}^{′} + \frac{{β}_{x}}{{γ}_{z}}$$

and LN_{xyz}=A″_{xyz}×γ_{z}. LN_{xyz} may be the output of the layer normalization operation.

A feed forward layer (e.g., the feed forward layer 143 and the feed forward layer 155) may be a position-wise fully-connected feed forward network. In an example, the feed forward layer may include two linear layers with an activation function in between. An example of the activation function is Rectified Linear Unit (ReLU).

FIG. 2 illustrates an embedding operation in an embedding layer 200, in accordance with various embodiments. The embedding layer 200 may be an example of the embedding layer 113 or the embedding layer 123 in FIG. 1. As shown in FIG. 2, the embedding layer 200 receives an input sequence 201, which includes three words 202, 203, and 204. Each word may be a token. The embedding layer 200 generates a vector embedding 205 from the word 202. The embedding layer 200 also generates a vector embedding 206 from the word 203. The embedding layer 200 further generates a vector embedding 207 from the word 204. In the embodiments of FIG. 2, the vector embeddings 205, 206, and 207 have the same dimension, i.e., they each have five data elements. In other embodiments, the vector embedding 205, 206, or 207 may have a different dimension. Also, the input to the embedding layer 200 may be data of a type other than words, such as audio signals, images, and so on.

In some embodiments where the embedding layer 200 is in an encoder (e.g., the encoder block 110), the input sequence 201 may be an input received by the encoder, such as a prompt made by a user. The input sequence 201 may remain the same during inference of the encoder. In some embodiments where the embedding layer 200 is in a decoder (e.g., the decoder block 120), the input sequence 201 may change and the dimension of the input sequence 201 may be dynamic during inference of the decoder. In an example, the decoder inference may include a sequence of phases. Each inference stage may be conducted to predict a token. For the first inference stage, the input sequence 201 may include one or more start tokens. For each subsequent inference stage (e.g., the second inference stage, the third inference stage, etc.), the input sequence 201 may include tokens predicted in the previous inference stages. The dimension of the input sequence may be increased by one after each inference stage.

FIG. 3 illustrates a positional encoding operation in a positional encoding layer, in accordance with various embodiments. The positional encoding layer may be an example of the positional encoding layer 115 or the positional encoding layer 125 in FIG. 1. The positional encoding operation includes an addition of a vector embedding 310 and a positional encoding vector 320. The vector embedding 310 may be generated by an embedding layer. The positional encoding vector 320 may encode information of the position of the token represented by the vector embedding 310 in a sequence of tokens. The positional encoding operation computes a vector embedding 330, which represents the token with positional context. In some embodiments, the positional encoding operation may be an elementwise addition operation. A data element in the vector embedding 330 may equal the sum of a data element in the vector embedding 310 and a data element in the positional encoding vector 320. In the embodiments of FIG. 3, the vector embedding 310, positional encoding vector 320, and vector embedding 330 have the same dimension, i.e., they each have five data elements. In other embodiments, the vector embedding 310, positional encoding vector 320, or vector embedding 330 may have a different dimension.

FIGS. 4A and 4B illustrate an example MHA layer 400, in accordance with various embodiments. The MHA layer 400 may be an example of the MHA layer 141 or the MHA layer 151 in FIG. 1. As shown in FIG. 4A, the MHA layer 400 includes linear layers 410, 420, and 430, a MatMul layer 440, a scale layer 450, a SoftMax layer 460, another MatMul layer 470, a concatenation layer 480, and another linear layer 490. In other embodiments, the MHA layer 400 may include fewer, more, or different layers. For instance, the scale layer 450 or mask layer 455 may be optional.

The MHA layer 400 receives an input 405. The input 405 may be token embeddings, which may be generated by an embedding layer or a positional encoding layer. The input 405 is fed into linear layers 410, 420, and 430 are in a linear block 415 of the MHA layer 400. In some embodiments, the MHA layer 400 includes a plurality of linear blocks that includes the linear block 415. For the purpose of illustration, the MHA layer 400 includes h linear blocks in FIG. 4A, where h is an integer. Each of the linear blocks may have the same layers as the linear block 415. Each linear block may compute three parameter matrices from the input 405. As shown in FIG. 4A, the linear layers 410, 420, and 430 outputs a query matrix 401, key matrix 402, and value matrix 403, respectively. In some embodiments, a MatMul operation in the linear layer 410 is applied on the input 405 and a query weight matrix

$${W}_{Q}^{i} ∈ {ℝ}^{{d}_{model} \times {d}_{q}} ,$$

which results in the query matrix 401. A MatMul operation in the linear layer 420 is applied on the input 405 and a key weight matrix

$${W}_{K}^{i} ∈ {ℝ}^{{d}_{model} \times {d}_{k}} ,$$

in key matrix 402. A MatMul operation in the linear layer 430 is applied on the input 405 and a value weight matrix

$${W}_{V}^{i} ∈ {ℝ}^{{d}_{model} \times {d}_{v}} ,$$

which results in the value matrix 403. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h.

The MatMul layer 440, scale layer 450, mask layer 455, SoftMax layer 460, and MatMul layer 470 are in an attention block 425 of the MHA layer. The attention block 425 may implement a scaled dot-product attention mechanism. In some embodiments, the MHA layer 400 includes a plurality of attention blocks that includes the attention block 425. For the purpose of illustration, the MHA layer 400 includes h attention blocks in FIG. 4A. Each of the attention blocks may have the same layers as the attention block 425. The linear block 415 and attention block 425 may constitute a head of the MHA layer 400. As the MHA layer 400 has h linear blocks and h attention blocks, the MHA layer 400 has h heads.

In some embodiments, for each head, the query matrix 401 and key matrix 402 are fed into the MatMul layer 440, where an MatMul operation may be performed on the query matrix 401 and key matrix 402, which computes a matrix 407 shown in FIG. 4B. The matrix 407 may be referred to as a dot-product matrix QK. In some embodiments, the matrix 407 may establish the degree of emphasis each token should place on other tokens. The matrix 407 may be a score matrix that includes a plurality of scores. Each token may be assigned a score in relation to other tokens within the same time step. A higher score may indicate a higher focus or emphasis. The matrix 407 may be scaled in the scale layer 450. In some embodiments, the matrix 407 is scaled down in the scale layer 450 by dividing the scores in the matrix 407 by the square root of the dimension of the query vector and the key vector, which may be denoted as dₖ. The output of the scale layer 450 may be a scaled matrix 408, which may include adjusted scores.

The mask layer 455 may be optional in some embodiments. The mask layer 455 may add an attention mask (which may be an input to the attention block 425) to the scaled matrix 408 to mask out some elements in the scaled matrix 408. The positions of the masked-out elements may be defined by the attention mask. A SoftMax function of the SoftMax layer 460 may be applied on the output of the scale layer 450 or mask layer 455. The SoftMax function may emphasize high scores while diminishing low scores, which can enhance the model's ability to determine which tokens should get more attention. The SoftMax layer 460 outputs a matrix 409. The matrix 409 may be an attention weight matrix that includes attention weights. The attention weights may be probability values ranging from 0 to 1.

In the MatMul layer 470, a MatMul operation is performed on the matrix 409 and the value matrix 403. The resulting matrix, i.e., matrix 411 shown in FIG. 4B, may be a single-head matrix, which is an output of the attention block 425. As the MHA layer 400 has h attention blocks, there can be h single-head output matrices. The single-head output matrices are concatenated in the concatenation layer 480 to form a concatenated matrix. In the linear layer 490, an MatMul operation is performed on the concatenated matrix and an output weight matrix W^{O}∈ [symbol] ^{hd}^{ᵥ}^{×d}^{_{model}}, resulting in an output 406 of the MHA layer 400. In some embodiments, the MHA may be denoted as MultiHead(Q,K,V)=Concat (head₁, head₂, . . . , headₙ)W^{O}, where Concat denotes concatenation.

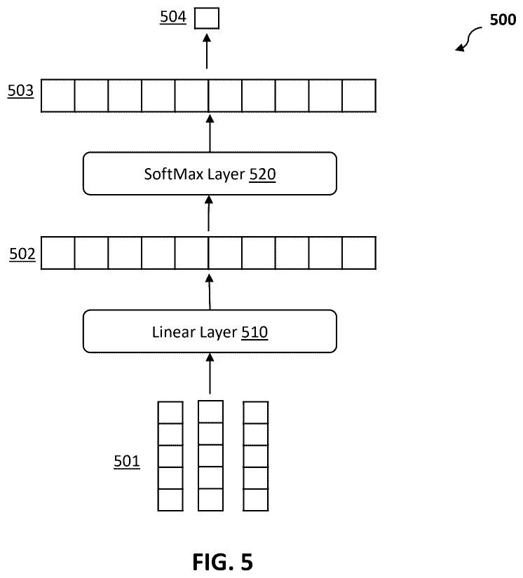

FIG. 5 illustrates an example linear classifier 500, in accordance with various embodiments. The linear classifier 500 may be used in transformer models. In some embodiments, the linear classifier 500 may generate tokens based on outputs of decoders. The linear classifier 500 may be an example of the linear block 130 in FIG. 1. As shown in FIG. 5, the linear classifier 500 includes a linear layer 510 and a SoftMax layer 520. In other embodiments, the linear classifier 500 may include fewer, more, or different components.

The linear layer 510 is provided with a matrix 501. The matrix 501 may be an output of a decoder, e.g., the decoder block 120. A linear transformation may be performed on the matrix 501 and a weight matrix in the linear layer 510. The weight matrix may include weights, which are internal parameters of the linear layer 510. The linear layer outputs a vector 502. In some embodiments, the dimension of the vector 502 (e.g., the total number of elements in the vector 502) may be equal to the total number of classes associated with the AI task being performed by the transformer model. The vector 502 is provided to the SoftMax layer 520. The SoftMax layer 520 generates a vector 503 from the vector 502. In some embodiments, the dimension of the vector 503 may equal the dimension of the vector 502. Each element in the vector 503 may correspond to a predicted token and may indicate a probability score of the predicted token. The probability score may indicate the probability that the prediction is correct. A predicted token 504 having the highest probability score may be selected and output from the linear classifier 500.

The output of the linear classifier 500 may be the output of the transformer model. The execution of the linear classifier 500 may be performed multiple times during inference of the transformer model. For instance, the transformer model may have multiple inference stages, and the linear classifier 500 may be executed at least once in each inference stage. The dimensions of the vectors and matrices shown in FIGS. 2-5 are example dimensions used for purpose of illustration and simplicity. Any of the vectors and matrices used or computed by operations illustrated in FIGS. 2-5 may have different dimensions.

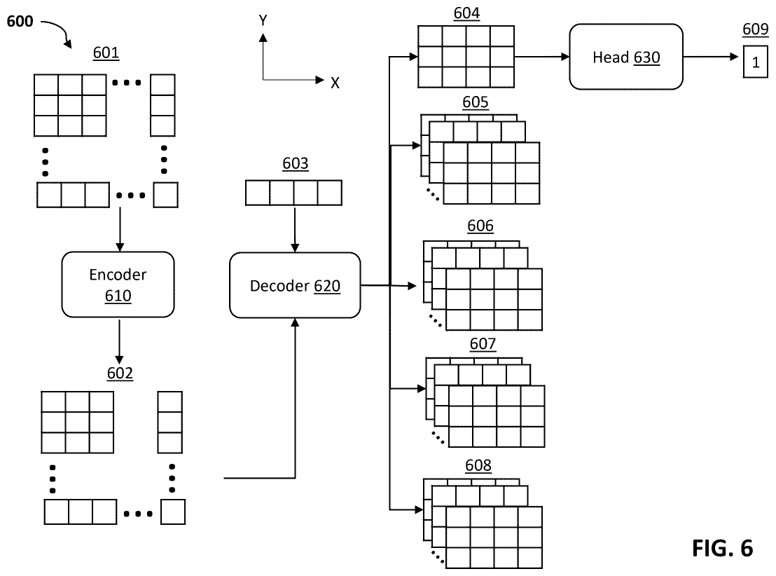

FIG. 6 illustrates a first inference stage of a transformer model 600, in accordance with various embodiments. The transformer model 600 includes an encoder 610, a decoder 620, and a head 630. An example of the transformer model 600 may be the transformer model 100 in FIG. 1. In the embodiments of FIG. 6, the encoder 610 receives an input tensor 601. The input tensor 601 may be a feature map extracted from one or more images, text documents, audio files, videos, other types of data, or some combination thereof. In some embodiments, the input tensor 601 may be generated by another neural network, e.g., a CNN. The encoder 610 generates an output tensor 602 from the input tensor 601. The shape of the output tensor 602 may be denoted as [batch size, SL_{encoder},d_{model}], where SL_{encoder} may be the dimension along the X axis (i.e., the width of the output tensor 602), and d_{model} may be the dimension along the Y axis (i.e., the height of the output tensor 602). The encoder 610 may include a plurality of layers arranged in a sequence, such as the layers inside the encoder block 110 in FIG. 1. The output tensor 602 is provided to the decoder 620.

The decoder 620 receives the output tensor 602 and an input sequence 603. The input sequence 603 may be a sequence of tokens. A token may be a numerical representation of an input signal, such as word, image, audio signal, video signal, etc. The dimension of the input sequence 603, which may be denoted as SLᵢₙₚᵤₜ, may be the total number of tokens in the input sequence 603. For the purpose of illustration and simplicity, SLᵢₙₚᵤₜ is 4. In other embodiments, the input sequence 603 may have a different shape. For instance, the input sequence 603 may be a 2D tensor. The dimension of the 2D tensor along the X axis may be SLᵢₙₚᵤₜ, while the dimension of the 2D tensor along the Y axis may be a batch size indicating the number of batches in the input sequence 603.

The decoder 620 computes an output tensor 604, a self-attention key tensor 605, a self-attention value tensor 606, a cross-attention key tensor 607, and a cross-attention value tensor 608. In some embodiments, the shape of the output tensor 604 may be denoted as [batch size, SLᵢₙₚᵤₜ,d_{model}]. The shape of the self-attention key tensor 605 or the shape of the self-attention value tensor 606 may be denoted as N×[batch size,h,SLᵢₙₚᵤₜ,d_{head}], where N is the number of identical layers in the decoder (e.g., the number of layers 150 in the decoder block 120), h is the total number of heads in a MHA layer, and d_{head} is the dimension of a query vector, key vector, or value vector. In some embodiments, d_{model}=h×d_{head}. The shape of the cross-attention key tensor 607 or the shape of the cross-attention value tensor 608 may be denoted as N×[batch size,h,SL_{encoder},d_{head}].

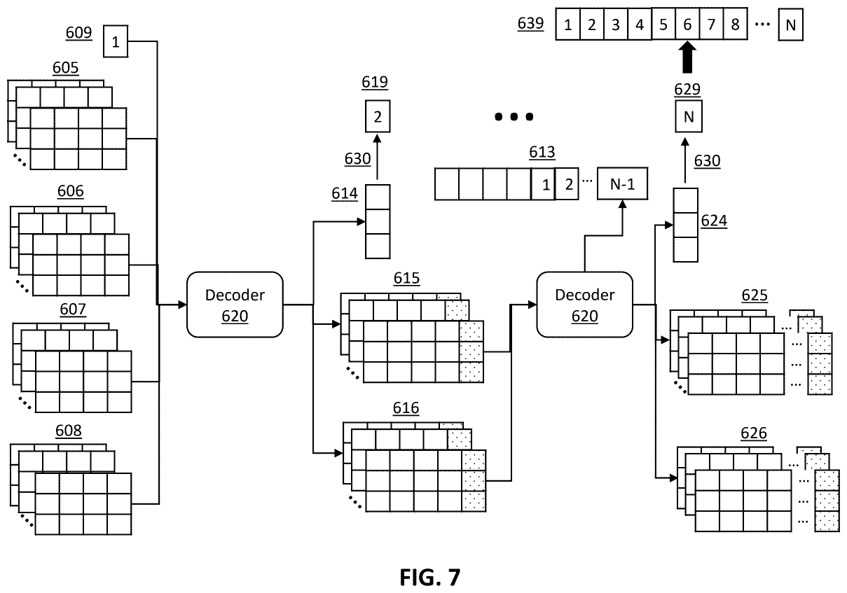

The output tensor 604 may be provided to the head 630 and the head 630 outputs a predicted token 609. The shape of the token 609 may be denoted as [batch size,1]. For the purpose of illustration and simplicity, batch size is 1 in FIG. 6. In other embodiments, batch size may be a larger number. The predicted token 609 may be stored in a buffer. In some embodiments, the predicted token 609 may be used to update the input sequence 603. For instance, the predicted token 609 may be added to the right of the input sequence 603. The updated input sequence may be used as the input sequence in the second inference stage. In the second inference stage, the decoder 620 may receive the updated input sequence and the output tensor 602 for predicting another token. The output tensor 602 may remain the same during inference of the decoder 620. Certain aspects of subsequent inference stages are described below in conjunction with FIG. 7.

In some embodiments, the self-attention key tensor 605 and the self-attention value tensor 606 may be provided to a self-attention layer in the decoder 620, an example of such a self-attention layer is the MHA layer 151. The self-attention key tensor 605 may be stored in a self-attention key cache. The self-attention key cache may have the same shape as the self-attention key tensor 605. The self-attention value tensor 606 may be stored in a self-attention value cache. The self-attention value cache may have the same shape as the self-attention value tensor 606.

In some embodiments, the decoder 620 computes the self-attention key tensor 605 and the self-attention value tensor 606 from the input sequence 603. The input sequence 603 may be dynamic during inference of the decoder 620. For instance, a new token may be added to the input sequence 603 after each inference stage, as described above. As the input sequence 603 changes, the self-attention key tensor 605 and the self-attention value tensor 606 would also change. For instance, the dimension of the self-attention key tensor 605 or the self-attention value tensor 606 along the X axis may increase as SLᵢₙₚᵤₜ increases. The self-attention key cache and the self-attention value cache may change during all the inference stages of the decoder 620 to accommodate the changes in the self-attention key tensor 605 and the self-attention value tensor 606.

In some embodiments, the cross-attention key tensor 607 and the cross-attention value tensor 606 may be provided to a cross-attention layer in the decoder 620, an example of such a cross-attention layer is the MHA layer 153. The cross-attention key tensor 607 may be stored in a cross-attention key cache. The cross-attention key cache may have the same shape as the cross-attention key tensor 607. The cross-attention value tensor 608 may be stored in a cross-attention value cache. The cross-attention value cache may have the same shape as the cross-attention value tensor 608. In some embodiments, the decoder 620 computes the cross-attention key tensor 607 and the cross-attention value tensor 606 from the output tensor 602 generated in the encoder 610. As the output tensor 602 does not change during inference of the decoder 620, the cross-attention key tensor 607 and the cross-attention value tensor 606 may remain the same during all the inference stages of the decoder 620. The cross-attention key cache and the cross-attention value cache may remain the same during all the inference stages of the decoder 620.

FIG. 7 illustrates subsequent inference stages of the transformer model, in accordance with various embodiments. In the second inference stage, the decoder 620 may reuse the self-attention key tensor 605, self-attention value tensor 606, cross-attention key tensor 607, and cross-attention value tensor 608. The decoder 620 also receives the predicted token 609. The decoder 620 may compute self-attention key vectors from the predicted token 609 and concatenate the self-attention key vectors with the self-attention key tensor 605 to generate a new self-attention key tensor 615. For instance, a self-attention key vector for each head may be added to the right of a self-attention key matrix in the self-attention key tensor 605, and the self-attention key vector and the self-attention key matrix may correspond to the same head. The elements highlighted with a dot pattern in the self-attention key tensor 615 are the self-attention key vectors generated from the predicted token 609.

Similarly, the decoder 620 may compute self-attention value vectors from the predicted token 609 and concatenate the self-attention value vectors with the self-attention value tensor 606 to generate a new self-attention value tensor 616. For instance, a self-attention value vector for each head may be added to the right of a self-attention value matrix in the self-attention value tensor 606, and the self-attention value vector and the self-attention value matrix may correspond to the same head. The elements highlighted with a dot pattern in the self-attention value tensor 616 are the self-attention value vectors generated from the predicted token 609.

The decoder 620 also generates an output tensor 614. The decoder 620 may generate the output tensor 614 using the new self-attention key tensor 615 and new self-attention value tensor 616. The output tensor 614 is used by the head 630 to generate another predicted token 619. The predicted token 619 is the output of the transformer model 600 in the second inference stage.

One or more other subsequent inference stages may be conducted. In each subsequent inference stage, the decoder 620 receives a token predicted in the previous inference stage, a self-attention key tensor generated in the previous inference stage, a self-attention value tensor generated in the previous inference stage, the cross-attention key tensor 607, and the cross-attention value tensor 608. The decoder 620 may, in the subsequent inference stage, generate a larger self-attention key tensor and a larger self-attention value tensor, in addition to an output tensor which can be used by the head 630 to predict a new token.

In embodiments where the total number of inference stages is N, the input sequence 603 is updated to an input sequence 613 after N−1 inference stages. In the last inference stage (i.e., the Nth inference stage), the decoder 620 may receive the predicted token generated in the (N−1)th inference stage, the self-attention key tensor generated in the (N−1)th inference stage, the self-attention value tensor generated in the (N−1)th inference stage, the cross-attention key tensor 607, and the cross-attention value tensor 608. The decoder 620 may generate a self-attention key tensor 625 and a self-attention value tensor 626 using the predicted token generated in the (N−1)th inference stage, the self-attention key tensor generated in the (N−1)th inference stage, and the self-attention value tensor generated in the (N−1)th inference stage. The dimensions of the self-attention key tensor 625 or self-attention value tensor 626 along the X axis is SLᵢₙₚᵤₜ+N. The decoder 620 also generates an output tensor 624, which is used by the head 630 to generate the last predicted token 629. The N tokens predicted by the transformer model in the N inference stages may constitute an output tensor 639, which may be the final output of the transformer model.

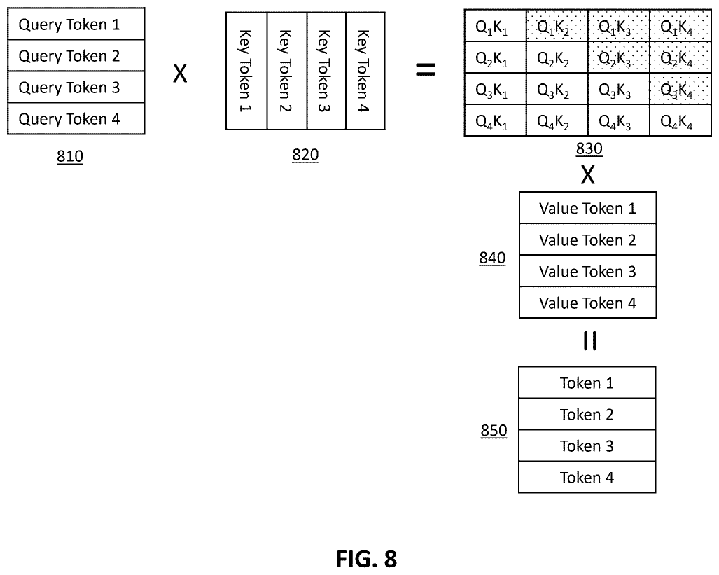

FIG. 8 illustrates computations in a self-attention layer without KV caching, in accordance with various embodiments. The self-attention layer may be a multi-head self-attention layer. In some embodiments, the self-attention layer is in a decoder of a transformer. The computations in the self-attention layer may include multiplication of a query matrix 810 and a key matrix 820, which results in an attention weight matrix 830. In some embodiments, the self-attention layer may be a masked self-attention layer. One or more elements in the attention weight matrix 830 may be masked. For instance, the elements highlighted with a dotted pattern in FIG. 8 may be masked. The computations in the self-attention layer also include multiplication of the attention weight matrix 830 and a value matrix 840, which results in an output matrix 850 encoding new tokens. In other embodiments, the computations in the self-attention layer may include other computations, such as computations with a scaling function, SoftMax function, and so on. For simplicity and illustration, these computations are not shown in FIG. 8.

Each of the query matrix 810, key matrix 820, and value matrix 840 may include a vector for each of the tokens in the input sequence. For illustration and simplicity, the input sequence has four tokens: tokens 1-4. In the embodiments of FIG. 8, as the decoder does not implement KV caching, computations on all the key tokens in the key matrix 820 and all the value tokens in the value matrix 840 need to be conducted. Some of the computations have already been conducted in the previous inference stage, e.g., computations on the key tokens 1-3 and computations on the value tokens 1-3. The duplication of these computations can be a waste of computational resources, such as power, time, and so on.

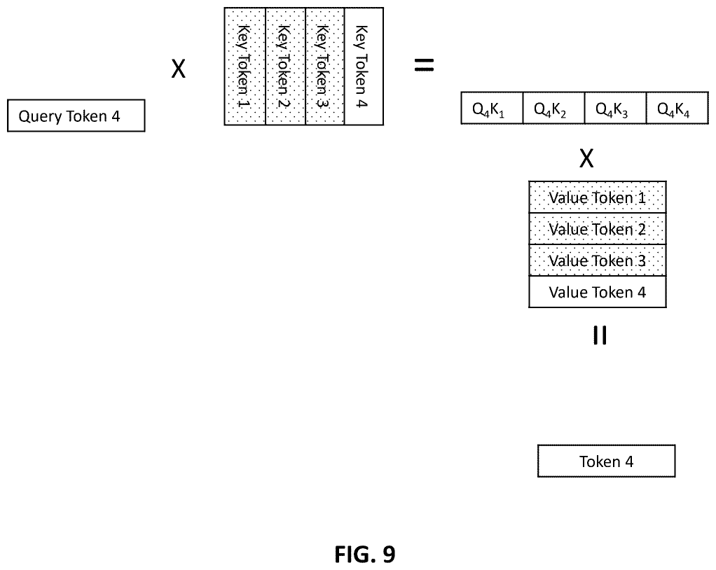

FIG. 9 illustrates computations in a self-attention layer with KV caching, in accordance with various embodiments. For illustration and simplicity, the self-attention in FIG. 9 may have the same query matrix, key matrix, and value matrix as the self-attention in FIG. 8. Different from the embodiments of FIG. 8, the decoder implements KV caching in the embodiment of FIG. 9. With the KV caching, the keys and values used in the previous inference stage(s) as well as data computed from the keys and values in the previous inference stage(s) are cached and can be reused in the current inference stage. The KV caching can reduce the amount of computations in the self-attention layer. Data that can be retrieved from cache is highlighted with a dotted pattern in FIG. 9. The amount of multiplication is reduced. Therefore, computational resources can be saved. The performance and efficiency of the transformer model can be improved. In some embodiments, the computations in FIG. 9 are computations in the fourth inference stage of a decoder, which is carried out after the generation of three tokens in three inference stages that were previously carried out.

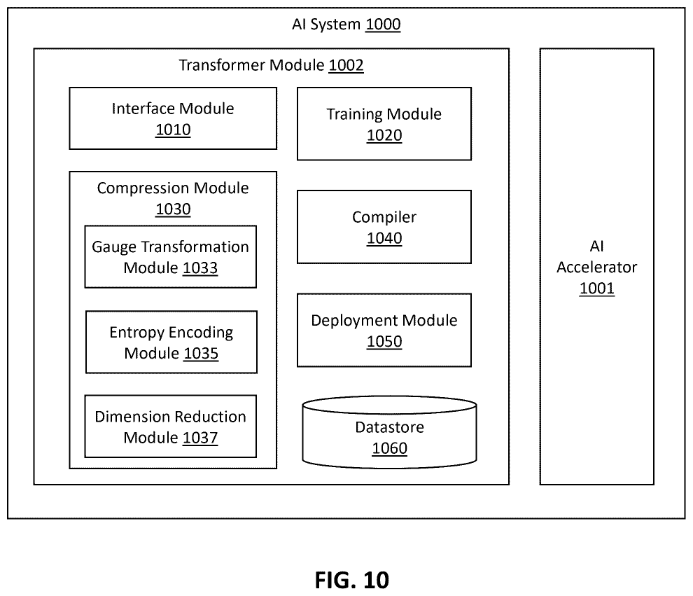

FIG. 10 is a block diagram of an AI system 1000, in accordance with various embodiments. The AI system 1000 can generate and execute transformer-based models, such as the transformer models described above. As shown in FIG. 10, the AI system 1000 includes an AI accelerator 1001 and a transformer module 1002. In other embodiments, alternative configurations, different or additional components may be included in the AI system 1000. For example, the AI system 1000 may include multiple AI accelerators or transformer modules. As another example, the AI system 1000 may include one or more GPUs, central processing units, etc. Further, functionality attributed to a component of the AI system 1000 may be accomplished by a different component included in the AI system 1000 or a different system. For instance, functionality attributed to the transformer module 1002 may be accomplished by the AI accelerator 1001, or vice versa. In some embodiments, the transformer module 1002 may be implemented in a processing unit that is separate from AI accelerator 1001. For instance, the transformer module 1002 may be implemented by one or more CPUs. The AI accelerator 1001 may also be referred to as a neural processing unit, DNN accelerator, or AI processor.

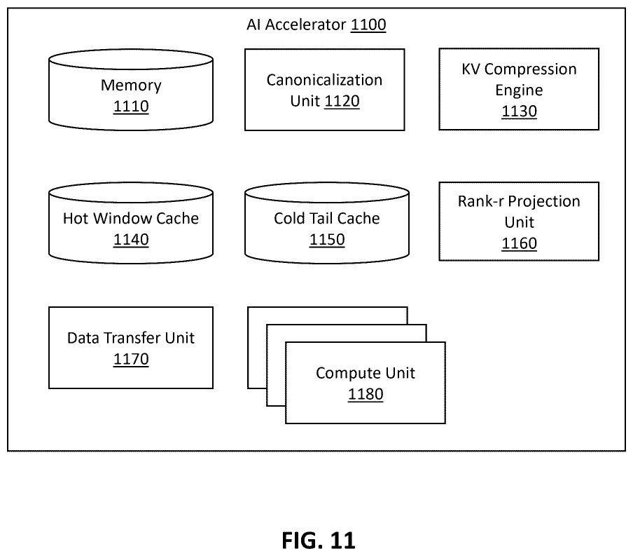

The AI accelerator 1001 may be a hardware device that can execute transformer models. For instance, the AI accelerator 1001 can execute a transformer model by carrying out neural network operations in the transformer model. The process of carrying out a neural network operation is also referred to as a process of executing the neural network operation or a process of performing the neural network operation. A neural network operation may be a layer (or a sublayer within a layer) of the transformer model. Examples of neural network operations include embedding operations, MatMul operation, additions, activation functions, and so on. The execution of the transformer model may be for training the transformer model or for deploying the transformer model to perform AI tasks. The AI accelerator 1001 may include data storage units and compute units. The data storage units, such as dynamic random-access memory (DRAM), SRAM, etc., may store data processed or generated by the compute units. The compute units may perform computations in neural network operations of transformer models. The data storage units may implement one or more look-up tables or KV cache for transformer model execution. A compute unit may include one or more multipliers, accumulators, shifters, other types of hardware components, or some combination thereof. Certain aspects regarding AI accelerator are described below in conjunction with FIG. 11.

The transformer module 1002 generates transformer models. In some embodiments, the transformer module 1002 may define the architecture of a transformer model and determine values of internal parameters (e.g., weights) of the model through one or roe training processes. The transformer module 1002 may also compress transformer models during or after training. For instance, the transformer module 1002 may canonicalize transformer models based on gauge transformation or compress KV cache of transformer models. The transformer module 1002 may further determine one or more hyperparameters that define how the transformer model is trained, compressed, or executed. Examples of hyperparameters may include training hyperparameters (e.g., batches, epochs, etc.), gauge transformation matrices for canonicalization, sliding window size for hot window cache, rank-r for KV caching, and so on. The transformer module 1002 may further compile transformer models (e.g., trained or compressed transformer models) to generate models executable by the AI accelerator 1001. In some embodiments, the transformer module 1002 may function as the host for transformer model inference. The transformer module 1002 may facilitate cached inference of the transformer model, in which keys and values of attention layers may be cached and reused during the inference of the transformer model. The inference for making the prediction may include a sequence of inference stages, which generates a sequence of predicted tokens. The sequence of predicted tokens may be the prediction of the transformer model.

As shown in FIG. 10, the transformer module 1002 includes an interface module 1010, a training module 1020, a compression module 1030, a compiler 1040, a deployment module 1050, and a datastore 1060. In other embodiments, alternative configurations, different or additional components may be included in the transformer module 1002. Further, functionality attributed to a component of the transformer module 1002 may be accomplished by a different component included in the transformer module 1002 or a different module or system.

The interface module 1010 facilitates communications of the transformer module 1002 with other modules or systems. For example, the interface module 1010 establishes communication between the transformer module 1002 with an external database to receive data that can be used to train transformer models or requests of deploying transformer models to perform tasks. As another example, the interface module 1010 supports the transformer module 1002 to distribute transformer models to computing devices configured to execute transformer models to perform tasks, such as the AI accelerator 1001.

The training module 1020 trains transformer models by using training datasets. The training module 1020 forms the training dataset. In an example where the training module 1020 trains a transformer model to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the transformer model, and the rest of the training dataset may be held back as a validation subset used by the training module 1020 to validate performance of a trained transformer model. The portion of the training dataset not including the tuning subset and the validation subset may be used to train the transformer model.

The training module 1020 also determines hyperparameters for training the transformer model. Hyperparameters are variables specifying the transformer model training process. Hyperparameters are different from parameters inside the transformer model (e.g., weights of filters). In some embodiments, hyperparameters include variables determining the architecture of the transformer model, such as number of hidden layers, etc. Hyperparameters also include variables which determine how the transformer model is trained, such as batch size, number of epochs, etc. A batch size defines the number of training samples to work through before updating the parameters of the transformer model. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the transformer model. An epoch may include one or more batches. The number of epochs may be 1, 5, 10, 50, 100, 500, 1000, or even larger.

The training module 1020 defines the architecture of the transformer model, e.g., based on some of the hyperparameters. An example of architecture defined by the training module 1020 is the architecture of transformer model 100 shown in FIG. 1. After the training module 1020 defines the architecture of the transformer model, the training module 1020 may input a training dataset into the transformer model. The training dataset includes a plurality of training samples and ground-truth labels of the training samples. A training sample may be an input (e.g., a sequence of input tokens, etc.) that can be fed into the transformer model. The ground-truth label of the training sample may be a known or verified prediction or decision made using the training sample. The training module 1020 may modify the parameters inside the transformer model (“internal parameters of the transformer model”) to minimize the error between labels of the training objects that are generated by the transformer model and the ground-truth labels of the objects. The internal parameters may include weights of filters in the convolutional layers of the transformer model. In some embodiments, the training module 1020 uses a cost function to minimize the error.

The training module 1020 may train the transformer model for a predetermined number of epochs. The number of epochs is a hyperparameter that defines the number of times that the deep learning algorithm can work through the entire training dataset. One epoch means that each sample in the training dataset has had an opportunity to update internal parameters of the transformer model. After the training module 1020 finishes the predetermined number of epochs, the training module 1020 may stop updating the parameters in the transformer model. The transformer model having the updated parameters is referred to as a trained transformer model.

The training module 1020 may also verify accuracy of trained or compressed transformer models. In some embodiments, the training module 1020 inputs samples in a validation dataset into a trained transformer model and uses the outputs of the transformer model to determine the model accuracy. In some embodiments, a validation dataset may be formed of some or all the samples in the training dataset. Additionally or alternatively, the validation dataset includes additional samples, other than those in the training sets. In some embodiments, the training module 1020 may determine an accuracy score measuring the precision, recall, or a combination of precision and recall of the transformer model. The training module 1020 may use the following metrics to determine the accuracy score: Precision=TP/(TP+FP) and Recall=TP/(TP+FN), where precision may be how many the transformer model correctly predicted (TP or true positives) out of the total it predicted (TP+FP or false positives), and recall may be how many the transformer model correctly predicted (TP) out of the total number of objects that did have the property in question (TP+FN or false negatives). The F-score (F-score=2*PR/(P+R)) unifies precision and recall into a single measure.

The training module 1020 may compare the accuracy score with a threshold score. In an example where the training module 1020 determines that the accuracy score of the transformer model is less than the threshold score, the training module 1020 may re-train the transformer model. In one embodiment, the training module 1020 may iteratively re-train the transformer model until the occurrence of a stopping condition, such as the accuracy measurement indication that the transformer model may be sufficiently accurate, or a number of training rounds having taken place.

The compression module 1030 compresses transformer models for more efficient transformer model execution. The transformer model execution may be for training models or for deploying trained transformer models to perform AI tasks. The compression module 1030 may compress a transformer model using various techniques, such as weight canonicalization, KV cache compression, and so on. In some embodiments, the compression module 1030 may leverage the maximal gauge symmetry of attention to reduce KV memory exactly or with certificates. As shown in FIG. 10, the compression module 1030 includes a gauge transformation module 1033, an entropy encoding module 1035, and a dimension reduction module 1037. In other embodiments, the compression module 1030 may include fewer, more, or different components.

The gauge transformation module 1033 may canonicalize weights of attention layers of a transformer model. For instance, the gauge transformation module 1033 may facilitate a one-time gauge canonicalization and rewrite weights so that the values are orthonormal and queries/keys are scale-balance, thereafter the model may produce KV data in a compression-friendly basis without changing its function or runtime floating-point operations (FLOPs). Runtime FLOP may refer to the actual measurement of the total number of FLOPs that is executed during the runtime, e.g., during the time of the AI accelerator 1001 executing the transformer model. Gauge canonicalization can yield bit-identical outputs (e.g., FP32 deterministic) with measurable KV reductions.

An attention layer of the transformer model may have a plurality of weight matrices. The weights of these weight matrices may be determined by training the transformer model. The weight matrices may include a query weight matrix W_{Q}, key weight matrix W_{K}, value weight matrix W_{V}, and output weight matrix W_{O}. These weight matrices may also be referred to as projection matrices. The attention layer may receive input embeddings and convert the input embeddings into queries, keys, and values using the query weight matrix W_{Q}, key weight matrix W_{K}, and value weight matrix W_{V}, respectively. A MatMul operation and SoftMax function may be applied on the queries and values. The resulting matrix of the SoftMax function and the values may go through an MatMul operation, the result of which may be converted to an output matrix of the attention layer using the weight matrix W_{O}.

The attention layer may have h query heads and g K/V heads. In some embodiments (e.g., embodiments where the attention layer is an MHA layer), h=g. In other embodiments (e.g., embodiments where the attention layer is a GQA or MQA layer), h≥g. The per-head weight matrix may be denoted as

$${W}_{Q}^{i} , {W}_{K}^{i} ∈ {ℝ}^{{d}_{model} \times {d}_{k}} , {W}_{V}^{i} ∈ {ℝ}^{{d}_{model} \times {d}_{v}} , and {W}_{O}^{( i )} ∈ {ℝ}^{{d}_{v} \times {d}_{model}} ,$$

where i is the index of the head, d_{q} is the dimension of a query tensor, dₖ is the dimension of a key tensor, dᵥ is the dimension of a value tensor. In some embodiments, d_{q}=dₖ=dᵥ=d_{model}/h. The attention layer may compute queries qₜ, keys kₛ, and values vₛ from hidden states, then mix values using SoftMax-normalized dot-product weights. The dot products of queries and keys may be denoted as

$${q}_{t}^{( i )} {k}_{s}^{( i ) T} .$$

SoftMax weights may be denoted as products of queries and keys may be denoted as

$${α}_{t}^{( i )} .$$

Outputs of the attention layer may be denoted as

$${\sum }_{s \leq t} {α}_{t , s}^{( i )} {v}_{s}^{( i )} {W}_{O}^{( i )} .$$

In an example, the input of an attention layer may be a sequence of n token embeddings, which may be denoted as X∈ [symbol] ^{n×d}^{_{model}}. Each attention head i={1, . . . , h} may compute queries

$${Q}_{i} = {XW}_{Q}^{( i )} ∈ {ℝ}^{n \times {d}_{k}} ,$$

keys

$${K}_{i} = {XW}_{K}^{( i )} ∈ {ℝ}^{n \times {d}_{k}} ,$$

and values

$${V}_{i} = {XW}_{V}^{( i )} ∈ {ℝ}^{n \times {d}_{v}}$$

through linear projections. The SoftMax function may act row-wise over tokens. The scaled dot-product attention for head i may be

$${B}_{i} ( X ) = softmax ( \frac{{Q}_{i} {K}_{i}^{T}}{\sqrt{{d}_{k}}} ) {V}_{i} ,$$

where Bᵢ∈ [symbol] ^{n×d}^{ᵥ}. The MHA output may be

$$MHA ( X ) = [ {B}_{1} ( X ) ‖ … ‖ {B}_{H} ( X ) ] {W}_{O} = {\sum }_{i = 1}^{h} {B}_{i} ( X ) {W}_{O , i}$$

with

$${W}_{O}^{( i )} ∈ {ℝ}^{{d}_{v} \times {d}_{model}}$$

partitioned into blocks

$${W}_{O , i}^{( i )} ∈ {ℝ}^{{d}_{v} \times {d}_{model}} .$$

An example of transformer attention layers is the MHA layer 400 in FIG. 4.

The gauge transformation module 1033 may canonicalize the weight matrices through a one-time transformation of the weight matrices. The gauge transformation module 1033 may determine two invertible matrices for each head: a first matrix A for the query-key space and a second matrix C for the value space. The gauge transformation module 1033 may facilitate a gauge transformation in which queries are multiplied by A (i.e., Ŵ_{Q}=W_{Q}A), keys by inverse transpose of A (i.e., Ŵ_{K}=W_{K}A^{-T}), values by C, and output projections by C⁻¹. This transformation may preserve all dot products between queries and keys, maintaining attention weights unchanged, while the second matrix and inverse of the second matrix operations may cancel in the value path, preserving the final output.

The gauge transformation module 1033 may make specific choice of these transformation matrices. For the value space, the gauge transformation module 1033 may perform QR decomposition on the original value projection matrix W_{V} to obtain orthonormal columns Q_{V} and upper triangular R_{V}. QR decomposition, which may also be referred to as QR factorization or QU factorization, may be a decomposition of a matrix into a product QR of an orthonormal matrix Q and an upper triangular matrix R. The QR decomposition may be denoted as QR(W_{V})=Q_{V} R_{V}. The gauge transformation module 1033 may

$$C = {R}_{V}^{- 1} ,$$

which may transform the value projection matrix to Q_{V}. The transformation of the value projection matrix may be denoted as Ŵ_{V}=Q_{V}. Q_{V} may orthonormal columns. This orthonormalization may concentrate energy into the leading coordinates, making the values amenable to both lossless compression through entropy coding and lossy compression through rank truncation with bounded error.

For the query-key space, the gauge transformation module 1033 may compute the geometric mean of the query and key Gram matrices:

$${S}_{Q} = {W}_{Q}^{T} {W}_{Q} and {S}_{K} = {W}_{K}^{T} {W}_{K} .$$

A Gram matrix may be a symmetric matrix where each entry is an inner product of pairs of vectors from a given set. This geometric mean may represent the unique positive definite matrix that simultaneously balances the scales of queries and keys. The gauge transformation module 1033 may define

$$M = {S}_{Q}^{1 / 2} {S}_{K} {S}_{Q}^{1 / 2}$$

and set

$$A = {S}_{Q}^{- 1 / 2} {M}^{1 / 4} {S}_{Q}^{- 1 / 4} .$$

This may yield A^{T}S_{Q}A=A⁻¹S_{K}A^{-T}=S_{Q}≠S_{K} (the matrix geometric mean). In some embodiments, the gauge transformation module 1033 may compute S_{Q} and S_{K} in FP32. In some embodiments, the gauge transformation module 1033 may find matrix G that satisfies GS_{Q}⁻¹G=S_{K}. The solution is given by the matrix geometric mean

$$G = {{S}_{Q}^{1 / 2} ( {S}_{Q}^{- 1 / 2} {S}_{K} {S}_{Q}^{- 1 / 2} )}^{1 / 2} {S}_{Q}^{1 / 2} .$$

The gauge transformation module 1033 may form the geometric mean with FP32 accumulation. The transformation matrix

$$A = {S}_{Q}^{- 1 / 2} {G}^{1 / 2} ,$$

where G=S_{Q}≠S_{K}. This balancing operation can equalize the dynamic range across dimensions, improving compressibility particularly for models using rotary position embeddings

In an example, for a head i of the attention layer, the gauge transformation module 1033 may determine a transformation matrix Aᵢ∈GL(dₖ) for the query-key space and a transformation matrix Cᵢ∈GL(dᵥ) for the value space. The gauge transformation module 1033 may determine Aᵢ and Cᵢ such as

$${W}_{V}^{( i )} {C}_{i} T$$

has orthonormal columns and

$${W}_{Q}^{( i )} {A}_{i} , {W}_{K}^{( i )} {A}_{i}^{- T}$$

are scale balanced, i.e.,

$${A}_{i}^{T} {S}_{Q} {A}_{i} = {A}_{i}^{- 1} {S}_{K} {A}_{i}^{- T} .$$

The gauge transformation module 1033 may compute

$${QRW}_{V}^{( i )} = {Q}_{V}^{( i )} {R}_{V}^{( i )}$$

and set

$${C}_{i} = {( {R}_{V}^{( i )} )}^{- 1} .$$

In some embodiments, the gauge transformation module 1033 may also transform the weight matrices of the head using the transformation matrices, such as using the transformation matrix Aᵢ∈GL(dₖ) for the query-key space and using the transformation matrix Cᵢ∈GL(dᵥ) for the value space. The gauge transformation module 1033 may use the transformation matrix Aᵢ to canonicalize

$${W}_{Q}^{( i )} and {W}_{K}^{( i )} .$$

The gauge transformation module 1033 may use the transformation matrix Cᵢ to canonicalize

$${W}_{V}^{( i )} and {W}_{O}^{( i )} .$$

In an example, the weight canonicalization may be denoted as:

$${W}_{Q}^{( i )} , {W}_{K}^{( i )} ↦ {W}_{Q}^{( i )} {A}_{i} , {W}_{K}^{( i )} {A}_{i}^{− T} and {W}_{V}^{( i )} , {W}_{O}^{( i )} ↦ {W}_{V}^{( i )} {C}_{i} , {C}_{i}^{- 1} {W}_{O}^{( i )} .$$

The canonicalized query weight matrix is

$${\hat{W}}_{K}^{( i )} = {W}_{K}^{( i )} {A}_{i}^{- T} .$$

The canonicalized key weight matrix is

$${\hat{W}}_{Q}^{( i )} = {W}_{Q}^{( i )} {A}_{i} .$$

The canonicalized value weight matrix is

$${\hat{W}}_{V}^{( i )} = ↦ {W}_{V}^{( i )} {C}_{i} .$$

The canonicalized output weight matrix is

$${\hat{W}}_{O}^{( i )} = {C}_{i}^{- 1} {W}_{Q}^{( i )} .$$

The AI accelerator 1001 may execute the attention layer using the canonicalized weights, in lieu of the original weights. The attention layer modified with the canonicalized weight may be referred to as a canonicalized or transformed attention layer or a gauge invariance of the attention layer. The transformer model with the modified attention layer may be referred to as a canonicalized model or transformed model. In some embodiments, the gauge invariance of attention may be denoted as

$${\hat{q}}_{t}^{( i )} = {x}_{t}^{T} {\hat{W}}_{Q}^{( i )} = {x}_{t}^{T} {W}_{Q}^{( i )} {A}_{i} , {\hat{k}}_{s}^{( i )} = {x}_{s}^{T} {\hat{W}}_{K}^{( i )} = {x}_{s}^{T} {W}_{K}^{( i )} {A}_{i}^{− T} , {\hat{v}}_{s}^{( i )} = {x}_{s}^{T} {\hat{W}}_{V}^{( i )} = {x}_{s}^{T} {W}_{V}^{( i )} {C}_{i} .$$

The row-SoftMax at temperature τ may be denoted as

$${q}_{t}^{( i )} .$$

With the canonicalize weights, dot products

$${q}_{t}^{( i )} {k}_{s}^{( i ) T} ,$$

weights

$${q}_{t}^{( i )} ,$$

and outputs

$${\sum }_{s \leq t} {α}_{t , s}^{( i )} {v}_{s}^{( i )} {W}_{O}^{( i )}$$

may remain unchanged, meaning

$${\hat{q}}_{t}^{( i )} {\hat{k}}_{s}^{( i ) T} = {q}_{t}^{( i )} {k}_{s}^{( i ) T} , {\hat{α}}_{t}^{( i )} = {α}_{t}^{( i )} , and {\sum }_{s \leq t} {\hat{α}}_{t , s}^{( i )} {\hat{v}}_{s}^{( i )} {\hat{W}}_{O}^{( i )} = {\sum }_{s \leq t} {α}_{t , s}^{( i )} {v}_{s}^{( i )} {W}_{O}^{( i )} .$$

When the per-head outputs of the attention layer are unchanged, the block hidden state hₜ is also unchanged.

The attention mechanism may operate through two independent computational pipelines that each has internal degrees of freedom. The attention scores may depend on the bilinear form QK^{T}=XW_{Q}(W_{K})^{T}X^{T}. Any transformation that preserves this product can leave the attention scores unchanged. The value transformation depends on the composed mapping VW_{O}=XW_{V}W_{O}. Transforming (W_{Q},W_{K}) [symbol] (W_{Q}A,W_{K}(A⁻¹)^{T}) can preserve the query-key product, while (W_{V},W_{O}) [symbol] ((W_{V}C,C⁻¹W_{O}) can preserve the value-output composition, any invertible matrices A and C of approximate dimensions.

The gauge transformation module 1033 may perform canonicalization that can lead to orthonormal V and balanced-scale K. The orthonormal V can concentrate energy so delta or residuals can be narrow. The balanced-scale K can reduce plane-wise skew under rotary position embeddings (ROPE), improving shared bit-width decisions. In some embodiments (e.g., embodiments where the transformer model employs RoPE), the gauge transformation module 1033 may respect the block-diagonal structure of the rotation matrices when transforming the weight matrices. For instance, the gauge transformation module 1033 may apply the transformation separately to each 2×2 rotation plane, effectively treating each plane as an independent complex-valued dimension. In some embodiments, the gauge transformation module 1033 may group dₖ coordinates into 2×2 ROPE planes, the commutant may be block-diagonal with blocks

$$( \begin{matrix}{a}_{j} & - {b}_{j} \\ {b}_{j} & {a}_{j}\end{matrix} )$$

(equivalently, complex scaling aⱼ+ibⱼ) per plan, i.e., C_{RoPE}≅(GL(1, [symbol] )^{d}^{ₖ}^{/2}. The per-layer gauge may become C_{RoPE}=(C_{RoPE})^{h}×(GL(dᵥ)^{h}) [symbol] Sₕ.

The entropy encoding module 1035 may compress keys and values computed using canonicalized weights, e.g.,

$${\hat{k}}_{s}^{( i )} and {\hat{v}}_{s}^{( i )} .$$

On top of gauge canonicalization by the gauge transformation module 1033, the entropy encoding module 1035 can further compress KV data with quantization. KV data after canonicalization may be stored into a hot window cache and a cold tail cache. In some embodiments, the hot window cache may store uncompressed KV data (e.g., KV data computed from the canonicalized weights), while the cold tail cache may store compressed KV data (e.g., KV data generated by the entropy encoding module 1035). The hot window cache may be a faster cache memory than the cold tail cache. The entropy encoding module 1035 may facilitate maintenance of a hot window of length W and a compressed tail in blocks of size B. In some embodiments, the entropy encoding module 1035 may determine the window length W and block size B based on available memory bandwidth or model accuracy/quality requirement.

In some embodiments, the entropy encoding module 1035 may select a subset of the keys and values to compress. For instance, the entropy encoding module 1035 may bypass the compression of keys and values in a hot window. The hot window may correspond to a sequence of relatively new tokens within the entire token sequence generated during the transformer model execution. The hot window may be a slide window. After a new token is generated, the hot window may slide over a previously generated token to include the new token, and the previously generated token may fall out of the hot window. The hot window may have a window size that indicates the length of the token sequence in the hot window, which may be smaller than the entire token sequence length. The window size may be fixed. The keys and values of the hot window may be stored in a hot window cache.

The entropy encoding module 1035 may compress the keys and values corresponding to tokens outside the hot window. In some embodiments, the entropy encoding module 1035 may compress keys and values using entropy encoding. The entropy encoding module 1035 may apply lossless or lossy compression techniques that can exploit the statistical redundancy in KV cache data to reduce its size. In some embodiments, the entropy encoding module 1035 may first quantize keys and values. The quantization may involve mapping continuous values to a smaller, finite set of discrete values. For instance, the entropy encoding module 1035 may convert a floating-point data precision (e.g., FP32) to an integer data precision (e.g., INT8). The quantization may reduce the KV data's entropy. The quantized values may have a more statistically predictable distribution, making the data more suitable for lossless entropy coding. The efficiency of entropy coding may depend on the probability distribution of the data. The entropy encoding module 1035 may profile these distributions, for example, by grouping KV values by block to create more accurate, low-entropy distributions for the entropy coder.

After the KV data is quantized and probabilities are established, the entropy encoding module 1035 may perform entropy coding to compress the data into a bitstream. In some embodiments, the entropy encoding module 1035 may use methods like arithmetic coding and Huffman coding. The entropy encoding module 1035 may represent frequent values with fewer bits, which can significantly decrease storage and bandwidth requirements. The entropy encoding module 1035 may store the compressed KV data in a cold tail cache. In some embodiments, the cold tail cache may be implemented in a cache memory that is slower than the hot window cache.

In some embodiments, the compression module 1030 may conduct performance profiling in production environments should monitor several key metrics to verify correct operation: the compression ratio achieved on the cold cache tail, the variance reduction pattern in canonicalized values, the balance of key vector magnitudes across rotation planes, and compliance with error bounds when using rank-r approximation. These metrics may provide operational visibility into the system's behavior and can trigger alerts if the compression characteristics deviate from expected ranges, potentially indicating issues with the canonicalization or changes in the model's activation patterns.

The mathematical structure of GaugeKV presents several opportunities for hardware-level optimizations that could significantly enhance performance and efficiency beyond pure software implementation. These optimizations span from better utilization of existing hardware features to potential custom accelerator designs that could make gauge-based compression a first-class hardware primitive.

The dimension reduction module 1037 may compress KV cache through rank-r value caching. The dimension reduction module 1037 may facilitate rank-r projection operation. For instance, the dimension reduction module 1037 may reduce the dimensionality of the key or value vectors of an attention layer. This can reduce the size of the KV cache and address the memory bottleneck caused by the KV cache, which grows linearly with the sequence length. In some embodiments, the original dimension of a key or value vector stored in a KV cache of an attention head may be dₖ or dᵥ. dₖ may equal dᵥ. The dimension reduction module 1037 may compress the KV cache by reducing dₖ to r. In some embodiments, r«dₖ.

In some embodiments, the dimension reduction module 1037 may reduce the dimension of the key or value vector by decomposing the weight matrices for the key and value projections (e.g., the canonicalized key weight matrix and the canonicalized value weight matrix computed by the gauge transformation module 1033) into low-rank matrices. In some embodiments, the weight matrices may be

$${\hat{W}}_{K}^{( i )} ∈ {ℝ}^{{d}_{model} \times {d}_{k}} and {\hat{W}}_{V}^{( i )} ∈ {ℝ}^{{d}_{model} \times {d}_{v}} .$$

The dimension reduction module 1037 may change the weight matrices to

$${W}_{K}^{( i )} ∈ {ℝ}^{{d}_{model} \times r} and {W}_{V}^{( i )} ∈ {ℝ}^{{d}_{model} \times r} .$$

In other embodiments, the weight matrices may be canonicalized weight matrices

$${\hat{W}}_{K}^{( i )} ∈ {ℝ}^{{d}_{model} \times {d}_{k}} and {\hat{W}}_{V}^{( i )} ∈ {ℝ}^{{d}_{model} \times {d}_{v}} .$$

The dimension reduction module 1037 may change the weight matrices to

$${\hat{W}}_{K}^{( i )} ∈ {ℝ}^{{d}_{model} \times r} and {\hat{W}}_{V}^{( i )} ∈ {ℝ}^{{d}_{model} \times r} .$$

During transformer model execution, the input token embeddings may be projected into this smaller latent space, and the compressed representations are cached.

Rank-r projection operation may involve storing the precomputed variance ordering for each head of an attention layer and truncating values to the specified rank during the forward pass. The dimension reduction module 1037 may compute error bounds in parallel with the projection, providing real-time monitoring of approximation quality without additional computational overhead. The dimension reduction module 1037 may dynamically adjust ranks based on available memory bandwidth and quality requirements, implementing the guardrail mechanism in hardware. For instance, the dimension reduction module 1037 may identify available memory bandwidth within the AI accelerator 1001. The dimension reduction module 1037 may determine quality or accuracy requirements based on the request for performing the AI task.

In some embodiments, the dimension reduction module 1037 may use guardrail to instantiate error bounds by adapting per-head ranks from residual energy while enforcing a global KV cap, ensuring the certified envelop is not violated in deployment. In some embodiments, the dimension reduction module 1037 may order coordinates by decreasing empirical tail energy and keep this order. The dimension reduction module 1037 may choose the first r coordinates. For a particular layer l and head i, the dimension reduction module 1037 may select the first r_{l,i} coordinates to cache, where l is the layer index. The dimension reduction module 1037 may determine the rank r based on an error budget or memory budget. For the error budget, the dimension reduction module 1037 may pick

$${r}_{l , i} s . t . {ξ}_{l , i} ( {r}_{l , i} ) {‖ {W}_{o}^{( l , i )} ‖}_{2 \to ∞} \leq {ϵ}_{V}^{( l , i )} ,$$

where Σ_{l,i}(r)= [symbol] ∥V(I−Pᵣ)∥₂, and Pᵣ is projected onto the first r value coordinates (e.g., according to per-head fixed order). The dimension reduction module 1037 may perform value truncation in the orthonormal basis:

$${‖ {\sum }_{s \leq t} {α}_{t , s} ‖}_{2 \to ∞} \leq {ϵ}_{V}^{( l , i )} .$$

The compiler 1040 compiles transformer models, including trained transformer models or compressed transformer models. Compressed transformer models may be models with compressed KV cache, such as canonicalized KV cache, quantized KV cache, rank-r KV cache, etc. The compiler 1040 may generate instructions (e.g., configuration parameters) that can be executed by AI accelerator 1001. The transformer module 1002 may write the instructions into configuration registers of the AI accelerator 1001. Components of the AI accelerator 1001 may operate in accordance with the instructions to execute the transformer model.

In some embodiments, the compiler 1040 may generate a graph representing a transformer model. The graph may include nodes and edges. A node may represent a specific neural network operation in the transformer model. An edge may connect two nodes and represent a connection between the two corresponding neural network operations. In an example, an edge may encode a tensor that flows from one of the neural network operations to the other neural network operation. The tensor may be an output tensor of the first neural network operation and an input tensor of the second neural network operation. The edge may encode one or more attributes of the tensor, such as size, shape, storage format, and so on. The compiler 1040 may use the graph to generate instructions (e.g., compilation descriptors). The instructions would be executed by components of the AI accelerator 1001 to execute the transformer model.

The deployment module 1050 may control and manage transformer model execution for performing AI tasks, including execution of transformer models with compressed KV cache. In some embodiments, the deployment module 1050 may distribute transformer models to devices or systems which may use the transformer models to perform tasks (e.g., image classification, motion planning, etc.) for which the transformer models were trained. In other embodiments, the deployment module 1050 may facilitate deployment of the transformer models using the AI accelerator 1001. For instance, the deployment module 1050 may receive transformer inference requests. A transformer inference request may be a request to deploy a transformer model to perform an AI task, e.g., language processing task, computer vision task, speech recognition task, and so on. The AI task may involve executing a transformer model to make a prediction based on input data. The deployment module 1050 may schedule transformer inference jobs based on attributes of the transformer models and attributes of the AI accelerator 1001.

In some embodiments, the deployment module 1050 may start a transformer inference job by sending information regarding the transformer inference to the other components of the transformer module 1002. For instance, the deployment module 1050 may instruct the training module 1020 to train a transformer model that can perform the job. The deployment module 1050 may instruct the compression module 1030 to compress a trained transformer model, e.g., based on available of computational resources in the transformer module 1002 and required or desired accuracy of the transformer. The deployment module 1050 may also instruct the compiler 1040 to compile a compressed model to generate an executable model. The deployment module 1050 may also instruct the transformer module 1002 to perform the inference in accordance with the schedule. The information provided by the deployment module 1050 may be included in the transformer inference request or generated by the deployment module 1050 based on the transformer inference request. For instance, the transformer inference request may indicate an accuracy requirement on the output of the transformer model. The deployment module 1050 may determine an accuracy threshold score based on the transformer inference request and instruct the training module 1020 or compression module 1030 to train or compress the transformer model based on the accuracy threshold score.

The datastore 1060 stores data received, generated, used, or otherwise associated with the transformer module 1002. For example, the datastore 1060 stores training datasets used by the training module 1020 to train transformer models. The datastore 1060 may also store data generated by the training module 1020, such as the hyperparameters for training DNNs, internal parameters of trained DNNs (e.g., weights, etc.), data for sparsity acceleration (e.g., sparsity bitmap, etc.), and so on. The datastore 1060 may also store data generated by the compression module 1030, such as transformation matrices, Gram matrices, canonicalized weights, hot window length, cold tail block size, rank-r values, and so on. The datastore 1060 may store graphs, configuration parameters, instructions, or other data generated by the compiler 1040 or the deployment module 1050. The datastore 1060 may include one or more memories. In the embodiment of FIG. 10, the datastore 1060 is a component of the transformer module 1002. In other embodiments, the datastore 1060 may be external to the transformer module 1002 and communicate with the transformer module 1002 through a network or interconnect fabric.

FIG. 11 is a block diagram of an AI accelerator 1100, in accordance with various embodiments. The AI accelerator 1100 can execute transformer models for training the models or for inference. The AI accelerator 1100 may be an example of the AI accelerator 1001 in FIG. 10. As shown in FIG. 11, the AI accelerator 1102 includes a memory 1110, canonicalization unit 1120, KV compression engine 1130, hot window cache 1140, cold tail cache 1150, rank-r projection unit 1160, data transfer unit 1170, and compute units 1180. In other embodiments, alternative configurations, different or additional components may be included in the AI accelerator 1102. Also, functionality attributed to a component of the AI accelerator 1102 may be accomplished by a different component of the AI accelerator 1102 or a different device.

The memory 1110 stores data received, processed, or generated by the AI accelerator 1102. The memory 1110 may be a system memory. The memory 1110 may include DRAM or SRAM. In some embodiments, the memory 1110 may store data to be used or generated by the compute units 1180 for transformer model execution. The memory 1110 may store weights, such as weights of attention layers, which are determined by training DNNs. The memory 1110 may also receive input data, such as input prompts for performing AI tasks by deploying transformer models. The memory 1110 may further store input tokens or output tokens of transformer models. The memory 1110 may also store intermediate values (e.g., queries, keys, values, etc.) computed during transformer model execution. In some embodiments, the memory 1110 may also store instructions or hyperparameters from the transformer module 1101.

The canonicalization unit 1120 may canonicalize keys and values generated during transformer model execution. The canonicalization unit 1120 may canonicalize data of attention layers using canonicalized weights of the attention layers. The canonicalization unit 1120 may implement or accomplish some or all functionalities attributed to the gauge transformation module 1033 described above in conjunction with FIG. 10. In an embodiment, the gauge transformation module 1033 may compute the transformation matrices (e.g., Aᵢ and Cᵢ for each head i of an attention layer), and the canonicalization unit 1120 may canonicalize the query weight matrix, key weight matrix, value weight matrix, and output weight matrix using the transformation matrices. The canonicalization of the weight matrices may be a one-time canonicalization. In another embodiment, the gauge transformation module 1033 may receive canonicalized query weight matrix, canonicalized key weight matrix, canonicalized value weight matrix, and canonicalized output weight matrix; and the canonicalization unit 1120 may receive the canonicalized weights from the gauge transformation module 1033 and use the canonicalized weights to execute the attention layer.

The canonicalization unit 1120 may provide canonicalize weight matrices to the compute units 1180. For instance, the canonicalization unit 1120 may store the canonicalize weight matrices into the memory 1110, and the compute units 1180 may read the canonicalize weight matrices from the memory 1110. The compute units 1180 may execute a gauge invariance of the attention layer, which is also referred to as a canonicalized attention layer. The canonicalized linear blocks for computing queries, keys, and values may be denoted as

$${\hat{q}}_{t}^{( i )} = {x}_{t}^{T} {\hat{W}}_{Q}^{( i )} = {x}_{t}^{T} {W}_{Q}^{( i )} {A}_{i} , {\hat{k}}_{s}^{( i )} = {x}_{s}^{T} {\hat{W}}_{K}^{( i )} = {x}_{s}^{T} {W}_{K}^{( i )} {A}_{i}^{- T} ,$$

$${\hat{v}}_{s}^{( i )} = {x}_{s}^{T} {\hat{W}}_{V}^{( i )} = {x}_{s}^{T} {W}_{V}^{( i )} {C}_{i} ,$$

respectively. The row-SoftMax at temperature τ may be denoted as

$${α}_{t}^{( i )} .$$

with the canonicalize weights, dot products

$${q}_{t}^{( i )} {k}_{s}^{( i ) T} ,$$

weights

$${α}_{t}^{( i )} ,$$

and outputs

$${\sum }_{s \leq t} {α}_{t , s}^{( i )} {v}_{s}^{( i )} {W}_{O}^{( i )}$$

may remain unchanged, meaning

$${\hat{q}}_{t}^{( i )} {\hat{k}}_{s}^{( i ) T} = {q}_{t}^{( i )} {k}_{s}^{( i ) T} , {\hat{α}}_{t}^{( i )} = {α}_{t}^{( i )} , and$$

$${\sum }_{s \leq t} {\hat{α}}_{t , s}^{( i )} {\hat{v}}_{s}^{( i )} {\hat{W}}_{O}^{( i )} = {\sum }_{s \leq t} {α}_{t , s}^{( i )} {v}_{s}^{( i )} {W}_{O}^{( i )} .$$

When the per-head outputs of the attention layer are unchanged, the block hidden state hₜ is also unchanged. The output of the canonicalized attention layer may be the same as the output of the attention layer without canonicalization. For instance, the output of the canonicalized attention layer may be bit-identical as the output of the attention layer without canonicalization. The canonicalization can lead to exact KV cache compression, meaning the KV cache is smaller, but the attention output or accuracy is not impacted.

In some embodiments, matrix operations by the gauge transformation module 1033 or canonicalization unit 1120 for weight canonicalization or matrix operations by the compute units 1180 for executing canonicalized attention layer may be performed in FP32 precision to avoid accumulation of numerical errors. Small eigenvalues may be clamped to prevent division by near-zero values, and the geometric mean computation may use the stable form involving square roots of the individual Gram matrices. In some embodiments, restriction may apply to orthogonal transformations to preserve the normalization statistics for models with query-key normalization layers. The gauge transformation can integrate seamlessly with existing serving infrastructure through standard model loading interfaces. For instance, the canonicalization process may occur once during model initialization, transforming the checkpoint in-place or creating a canonicalized version for repeated use. The transformed model may remain compatible with all existing optimization techniques including tensor parallelism, pipeline parallelism, and dynamic batching.

In some embodiments, the attention mechanism may operate through two independent computational pipelines that each has internal degrees of freedom. The attention scores may depend on the bilinear form QK^{T}=XW_{Q}(W_{K})^{T}X^{T}. Any transformation that preserves this product can leave the attention scores unchanged. The value transformation depends on the composed mapping VW_{O}=XW_{V}W_{O}. Transforming (W_{Q},W_{K}) [symbol] (W_{Q}A,W_{K}(A⁻¹)^{T}) can preserve the query-key product, while (W_{V},W_{O}) [symbol] ((W_{V}C,C⁻¹W_{O}) can preserve the value-output composition, any invertible matrices A and C of approximate dimensions.

The canonicalization can lead to orthonormal V and balanced-scale K. The orthonormal V can concentrate energy so delta or residuals can be narrow. The balanced-scale K can reduce plane-wise skew under ROPE, improving shared bit-width decisions. K and V may be stored after canonicalization into the hot window cache 1140 and cold tail cache 1150. In some embodiments, the hot window cache 1140 may store uncompressed KV data, while the cold tail cache 1150 may store compressed KV data. The hot window cache 1140 may be a faster cache memory than the cold tail cache 1150. In some embodiments, the hot window cache 1140 may reside in an on-chip SRAM or HBM cache, while the cold tail cache 1150 may use slower but denser memory technologies such as DRAM.

The KV compression engine 1130 may compress keys and values computed using canonicalized weights, e.g.,

$${\hat{k}}_{s}^{( i )} and {\hat{v}}_{s}^{( i )} .$$

The KV compression engine 1130 may implement or accomplish some or all functionalities attributed to the entropy encoding module 1035 described above in conjunction with FIG. 10. In some embodiments, the KV compression engine 1130 may select a subset of the keys and values to compress. For instance, the KV compression engine 1130 may bypass the compression of keys and values in a hot window. The hot window may correspond to a sequence of relatively new tokens within the entire token sequence generated during the transformer model execution. The hot window may be a slide window. After a new token is generated, the hot window may slide over a previously generated token to include the new token, and the previously generated token may fall out of the hot window. The hot window may have a window size that indicates the length of the token sequence in the hot window, which may be smaller than the entire token sequence length. The window size may be fixed. The keys and values of the hot window may be stored in the hot window cache 1140.

The KV compression engine 1130 may compress the keys and values corresponding to tokens outside the hot window. In some embodiments, the KV compression engine 1130 may compress keys and values using entropy encoding. The KV compression engine 1130 may apply lossless or lossy compression techniques that can exploit the statistical redundancy in KV cache data to reduce its size. In some embodiments, the KV compression engine 1130 may first quantize keys and values. The quantization may involve mapping continuous values to a smaller, finite set of discrete values. For instance, the KV compression engine 1130 may convert a floating-point data precision (e.g., FP32) to an integer data precision (e.g., INT8). The quantization may reduce the KV data's entropy. The quantized values may have a more statistically predictable distribution, making the data more suitable for lossless entropy coding. The efficiency of entropy coding may depend on the probability distribution of the data. The KV compression engine 1130 may profile these distributions, for example, by grouping KV values by block to create more accurate, low-entropy distributions for the entropy coder.

After the KV data is quantized and probabilities are established, the KV compression engine 1130 may perform entropy coding to compress the data into a bitstream. In some embodiments, the KV compression engine 1130 may use methods like arithmetic coding and Huffman coding. The KV compression engine 1130 may represent frequent values with fewer bits, which can significantly decrease storage and bandwidth requirements. The KV compression engine 1130 may store the compressed KV data in the cold tail cache 1150. In some embodiments, the cold tail cache 1150 may be implemented in a cache memory that is slower than the hot window cache 1140.

The rank-r projection unit 1160 facilitates rank-r projection operation. The rank-r projection unit 1160 may enable the canonicalization unit 1120, KV compression engine 1130, hot window cache 1140, cold tail cache 1150, data transfer unit 1170 or compute units 1180 to operate in a rank-r mode, in which weight matrices of attention layers have a reduced dimension r. The rank-r projection unit 1160 may implement or accomplish some or all functionalities attributed to the dimension reduction module 1037 described above in conjunction with FIG. 10. In some embodiments, the rank-r projection unit 1160 may receive the value of r from the dimension reduction module 1037 and may modify the weight matrices of attention layers based on the received value. In other embodiments, the rank-r projection unit 1160 may determine the value of r and used the determined value to modify the weight matrices of attention layers based on the received value. The rank-r projection unit 1160 may reduce a dimension of weight matrices and generate dimension-reduced weight matrices. The dimension-reduced weight matrices may be denoted

$${W}_{K}^{( i )} ∈ {ℝ}^{{d}_{model} \times r} and {W}_{V}^{( i )} ∈ {ℝ}^{{d}_{model} \times r} .$$

In some embodiments, the rank-r projection unit 1160 may perform dimension reduction on canonicalized weight matrices. In other embodiments, the rank-r projection unit 1160 may perform dimension reduction on weight matrices before the weight matrices are canonicalized. The canonicalized, dimension-reduced weight matrices may be denoted

$${\hat{W}}_{K}^{( i )} ∈ {ℝ}^{{d}_{model} \times r} and {\hat{W}}_{V}^{( i )} ∈ {ℝ}^{{d}_{model} \times r}$$

and may be stored in the memory 1110 for the compute units 1180 to perform canonicalized, dimension-reduced MatMul operations and generate canonicalized, dimension-reduced KV cache. The KV cache compression by the entropy encoding module 1035 or KV compression engine 1130 may be performed after the canonicalization and dimension reduction.

The data transfer unit 1170 transfers data between components of the AI accelerator 1100. For instance, the data transfer unit 1170 may write data computed by the canonicalization unit 1120, KV compression engine 1130, rank-r projection unit 1160 or compute units 1180 into the memory 1110, hot window cache 1140, or cold tail cache 1150. The data transfer unit 1170 may also read data stored in the memory 1110, hot window cache 1140, or cold tail cache 1150 into the canonicalization unit 1120, KV compression engine 1130, rank-r projection unit 1160 or compute units 1180. The data transfer unit 1170 may manage and perform data transfer operations within the AI accelerator 1100. The data transfer unit 1170 may also facilitate external data transfer, such as data transfer between the AI accelerator 1100 and the transformer module 1002 described above in conjunction with FIG. 10. The data transfer unit 1170 may include a direct memory access (DMA) engine.

The compute units 1180 perform computations for transformer model execution. For instance, the compute units 1180 may perform embedding operations, MatMul operations, activation function operations, or other types of neural network operations in transformer models. Each compute unit 1180 may include a plurality of multiply-accumulate (MAC) units. The MAC units may be arranged in a grid pattern and constitute an MAC array. Each MAC unit may include one or more multipliers and one or more adders. The compute units 1180 may support various floating-point or integer data formats, including FP32, FP16, BF16, FP4, INT8, and so on.

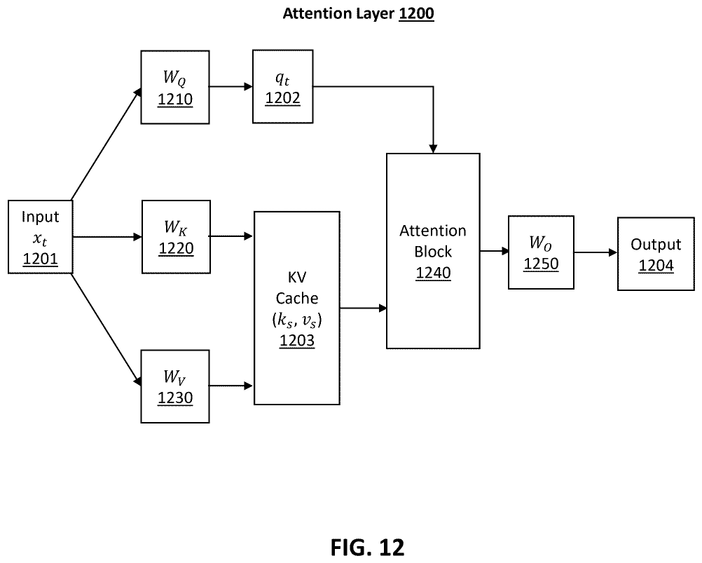

FIG. 12 illustrates a dataflow in an attention layer 1200 without weight canonicalization, in accordance with various embodiments. The attention layer 1200 receives an input 1201. The input 1201 is denoted as xₜ, which may be a tensor of token embeddings. The input 1201 is fed into MatMul layer 1210, MatMul layer 1220, and MatMul layer 1230. Each of the MatMul layer 1210, MatMul layer 1220, and MatMul layer 1230 receives the input 1201. The MatMul layer 1210 has a query weight matrix W_{Q}, the MatMul layer 1220 has a key weight matrix W_{K}, and the MatMul layer 1230 has a value weight matrix W_{V}. An example of the MatMul layer 1210 may be the linear layer 410 in FIG. 4A. An example of the MatMul layer 1220 may be the linear layer 420 in FIG. 4A. An example of the MatMul layer 1230 may be the linear layer 430 in FIG. 4A. The MatMul layer 1210 outputs a query matrix 1202, which is denoted as qₜ. The MatMul layer 1220 and MatMul layer 1230 outputs a key matrix kₛ and a value matrix vₛ, respectively, which are stored in a KV cache 1203.

The KV data in the KV cache 1203 is fed into an attention block 1240 for further computation. An example of the attention block 1240 is the attention block 425 in FIG. 4A. The output of the attention block 1240 is fed into a MatMul layer 1250, which has an output weight matrix W_{O}. An example of the MatMul layer 1250 may be the linear layer 490 in FIG. 4A. In the MatMul layer 1250, an MatMul operation is performed on the output of the attention block 1240 and the output weight matrix W_{O}, resulting in an output 1204.

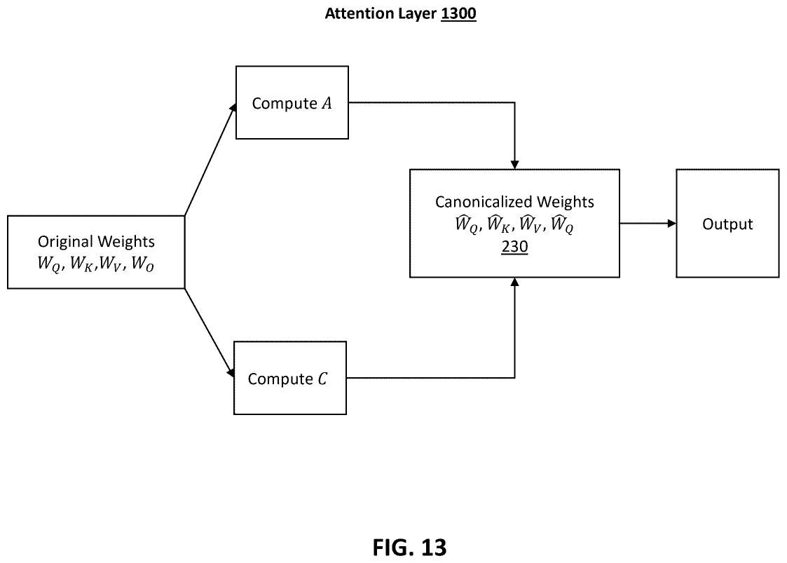

FIG. 13 illustrates a process of canonicalizing an attention layer, in accordance with various embodiments. Examples of the attention layer may include the MHA layer 400 in FIG. 4A and the attention layer 1200 in FIG. 12. The dataflow in FIG. 13 starts with the original weights of the attention layer, which include a query weight matrix W_{Q}, a key weight matrix W_{K}, a value weight matrix W_{V}, and an output weight matrix W_{O}. Transformation matrices A and C are generated from the original weights. Canonicalized weights are then computed from the transformation matrices A and C and original weights. The canonicalized weights include a canonicalized query weight matrix Ŵ_{Q}, a canonicalized key weight matrix Ŵ_{K}, a canonicalized value weight matrix Ŵ_{V}, and a canonicalized output weight matrix Ŵ_{O}. An output of the attention layer is computed from the canonicalized query weight matrix Ŵ_{Q}, canonicalized key weight matrix Ŵ_{K}, canonicalized value weight matrix Ŵ_{V}, and canonicalized output weight matrix Ŵ_{O}.

In some embodiments, the dataflow is performed by the gauge transformation module 1033 in FIG. 10, the canonicalization unit 1120 in FIG. 11, and the compute units 1180 in FIG. 11. For instance, the gauge transformation module 1033 may compute the transformation matrices, the canonicalization unit 1120 may generate the canonicalized weights from the transformation matrices and the original weights, and the compute units 1180 may generate the output from the canonicalized weights. The output may be bit-identical as the output 1204 in FIG. 12. In some embodiments, computations of the transformation matrices, the canonicalized weights, or the output may be performed in FP32 precision, validating the mathematical theory that the transformation preserves model function exactly.

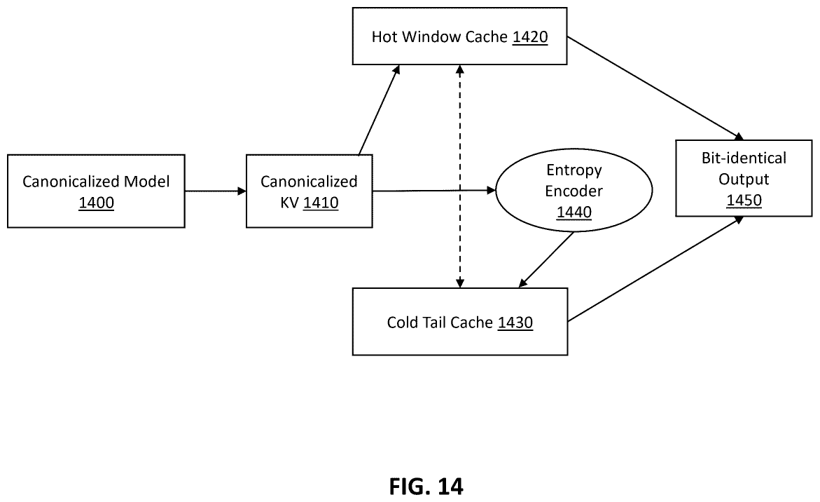

FIG. 14 illustrates a runtime operation with compressed KV cache, in accordance with various embodiments. The runtime operation may be an operation of transformer model inference for performing an AI task, such as a task of language processing, computer vision, speech recognition, and so on. The runtime operation uses a canonicalized model 1400. The canonicalized model 1400 may be a transformer model with canonicalized weights. For instance, weights of one or more attention layers of the transformer model may have been canonicalized through gauge transformation. The canonicalized model 1400 may be generated by the gauge transformation module 1033 in FIG. 10 or canonicalization unit 1120 in FIG. 11.

During the inference of the canonicalized model 1400, canonicalized KV 1410 is generated from the canonicalized weights. The canonicalized KV 1410 includes canonicalized keys \hat{k}ₛ and canonicalized values \hat{v}ₛ. In some embodiments, before the computation of the canonicalized KV 1410, the canonicalized weights may be converted by reducing a dimension of the weight matrices, e.g., from dₖ or dᵥ to r. After the dimension reduction, MatMul operations may be performed to compute the canonicalized KV 1410 from the canonicalized weight matrices with the reduced dimension.

A portion of the canonicalized KV 1410 is stored in a hot window cache 1420. Another portion of the canonicalized KV 1410 is stored in a cold tail cache 1430. The hot window cache 1420 may be faster than the cold tail cache 1430. For instance, it may take less time to read data from or write data into the hot window cache 1420 than the cold tail cache 1430. In some embodiments, the portion of the canonicalized KV 1410 stored in the hot window cache 1420 corresponds to W hot window tokens. The hot window may slide for each inference stage of the inference process so that it can encompass the most newly generated W tokens. The portion of the canonicalized KV 1410 stored in the cold tail cache 1430 corresponds to (T−W) cold tail tokens. The cold tail tokens may be tokens that fall outside the sliding hot window. T may be the total number of tokens.

An entropy encoder 1440 may compress keys and values stored in the cold tail cache 1430 through entropy encoding. An example of the entropy encoder 1440 may be the dimension reduction module 1037 in FIG. 10 or KV compression engine 1130 in FIG. 11. The compression by the entropy encoder 1440 can reduce the size of the cold tail cache 1430. The keys and values stored in the hot window cache 1420 may remain uncompressed. In some embodiments, the compressed keys and values in the cold tail cache 1430 have a lower data precision than the uncompressed keys and values in the hot window cache 1420. For instance, the data precision of the uncompressed keys and values may be FP32, while the data precision of the compressed keys and values may be INT8. In some embodiments, rank-r approximation with certified bounds may be used before or after the contraction of the canonicalized KV 1410 or entropy encoding by the entropy encoder 1440. The hot window cache 1420 and cold tail cache 1430 may be used to generate an output 1450 of the canonicalized model 1400. The output 1450 may be bit identical to an output of the original transformer model that is executed without canonicalization or compression.

The canonicalization, entropy encoding, and rank-r approximation can save memory be reducing sizes of the KV cache. For instance, block sizes of KV data in the hot window cache 1420 and cold tail cache 1430 can be reduced. The runtime system show in FIG. 14 can implement a two-tier caching strategy with a hot window for recent tokens and compressed storage for older context. The hot window size W and compression block size B can provide tunable parameters for balancing compression ratio against computational overhead. In some embodiments, the hot window size W or compression block size B may be determined by the entropy encoding module 1035 in FIG. 10 offline. For instance, the hot window size W and compression block size B may be determined during compilation and before the inference runtime. In an example, W or B may have a value in the range from 256 to 512. Larger values of W or B can lead to lower overhead at the cost of reduced compression.

Compression measurements can reveal consistent patterns across model architectures. These standalone improvements, while modest, can multiply with architectural optimizations to yield substantial system-level gains. When combined with GQA using eight KV heads serving thirty-two query heads, the total memory reduction can 4.4× to 4.8× for some implementations. Systems employing MQA see even greater benefits, with potential reductions exceeding 35× for models with thirty-two query heads. The rank-r approximation mode can provide controlled accuracy-memory tradeoffs with mathematical guarantees.

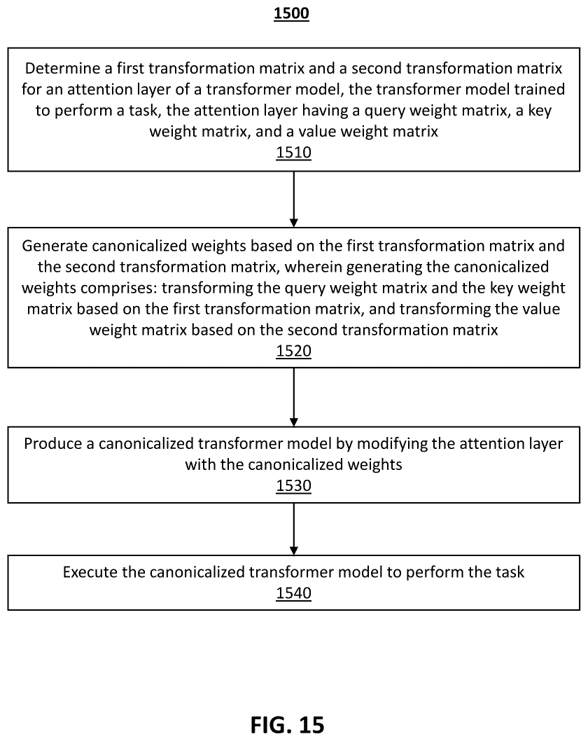

FIG. 15 is a flowchart of a method 1500 for executing a transformer model, in accordance with various embodiments. The method 1500 may be performed by the AI system 1000 in FIG. 10. Although the method 1500 is described with reference to the flowchart illustrated in FIG. 15, many other methods for executing transformer models may alternatively be used. For example, the order of execution of the steps in FIG. 15 may be changed. As another example, some of the steps may be changed, eliminated, or combined.

The AI system 1000 determines 1510 a first transformation matrix and a second transformation matrix for an attention layer of the transformer model. The transformer model is trained to perform a task. The attention layer has a query weight matrix, a key weight matrix, and a value weight matrix. In some embodiments, the attention layer further has an output weight matrix.

The AI system 1000 generates 1520 canonicalized weights based on the first transformation matrix and the second transformation matrix. The AI system 1000 generates the canonicalized weights by transforming the query weight matrix and the key weight matrix based on the first transformation matrix and transforming the value weight matrix based on the second transformation matrix. In some embodiments, the AI system 1000 transforms the query weight matrix using the first transformation matrix and transforms the key weight matrix using an inverse of a transpose of the first transformation matrix. In some embodiments, the AI system 1000 transforms the output weight matrix based on the second transformation matrix. In some embodiments, the value weight matrix is transformed using the second transformation matrix. The output weight matrix is transformed using an inverse of the second transformation matrix.

In some embodiments, the AI system 1000 reduces a dimension of the key weight matrix or value weight matrix. The canonicalized weights comprise a canonicalized key weight matrix or a canonicalized value weight matrix. The canonicalized key weight matrix or the canonicalized value weight matrix has the reduced dimension. In some embodiments, the AI system 1000 determines the reduced dimension of the key weight matrix or value weight matrix based on an available memory bandwidth of a hardware device executing the canonicalized transformer model or a requirement on an accuracy of the canonicalized transformer model.

The AI system 1000 produces 1530 a canonicalized transformer model by modifying the attention layer with the canonicalized weights. In some embodiments, the canonicalized weights include a canonicalized query weight matrix, a canonicalized key weight matrix, and a canonicalized value weight matrix. The modified attention layer has the canonicalized query weight matrix, canonicalized key weight matrix, and canonicalized value weight matrix, in lieu of the query weight matrix, key weight matrix, and value weight matrix.

The AI system 1000 executes 1540 the canonicalized transformer model to perform the task. In some embodiments, the AI system 1000 executes matrix multiplication operations of the modified attention layer to compute canonicalized KV data. The AI system 1000 stores a first portion of the canonicalized KV data in a first KV cache. The AI system 1000 stores a second portion of the canonicalized KV data in a second KV cache. The first KV cache is faster than the second KV cache. In some embodiments, the AI system 1000 determines a size of a sliding window, the size of the sliding window indicating a number of hot window tokens. The first portion of the canonicalized KV data comprises keys and values corresponding to the hot window tokens. In some embodiments, the AI system 1000 compresses the second portion of the canonicalized KV data so that the second portion of the canonicalized KV data in the second KV cache has a lower data precision than the first portion of the canonicalized KV data in the first KV cache. In some embodiments, the AI system 1000 compresses the second portion of the canonicalized KV data through entropy encoding.

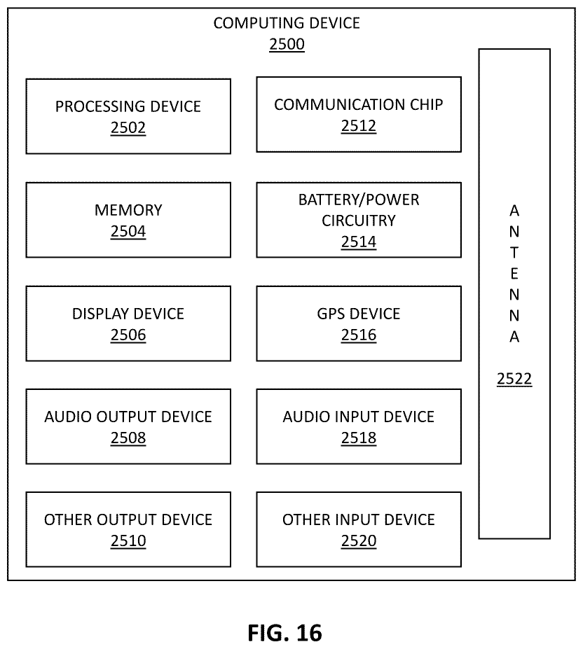

FIG. 16 is a block diagram of an example computing device 2500, in accordance with various embodiments. In some embodiments, the computing device 2500 can be used as at least part of the AI system 1000 in FIG. 1. A number of components are illustrated in FIG. 16 as included in the computing device 2500, but any one or more of these components may be omitted or duplicated, as suitable for the application. In some embodiments, some or all of the components included in the computing device 2500 may be attached to one or more motherboards. In some embodiments, some or all of these components are fabricated onto a single system on a chip (SoC) die. Additionally, in various embodiments, the computing device 2500 may not include one or more of the components illustrated in FIG. 16, but the computing device 2500 may include interface circuitry for coupling to the one or more components. For example, the computing device 2500 may not include a display device 2506, but may include display device interface circuitry (e.g., a connector and driver circuitry) to which a display device 2506 may be coupled. In another set of examples, the computing device 2500 may not include an audio input device 2518 or an audio output device 2508 but may include audio input or output device interface circuitry (e.g., connectors and supporting circuitry) to which an audio input device 2518 or audio output device 2508 may be coupled.

The computing device 2500 may include a processing device 2502 (e.g., one or more processing devices). The processing device 2502 processes electronic data from registers and/or memory to transform that electronic data into other electronic data that may be stored in registers and/or memory. The computing device 2500 may include a memory 2504, which may itself include one or more memory devices such as volatile memory (e.g., DRAM), nonvolatile memory (e.g., read-only memory (ROM)), HBM, flash memory, solid state memory, and/or a hard drive. In some embodiments, the memory 2504 may include memory that shares a die with the processing device 2502. In some embodiments, the memory 2504 includes one or more non-transitory computer-readable media storing instructions executable to perform operations for executing transformer models (e.g., the method 1500 described in conjunction with FIG. 15) or some operations performed by one or more components of the AI system 1000 in FIG. 10. The instructions stored in the one or more non-transitory computer-readable media may be executed by the processing device 2502.

In some embodiments, the computing device 2500 may include a communication chip 2512 (e.g., one or more communication chips). For example, the communication chip 2512 may be configured for managing wireless communications for the transfer of data to and from the computing device 2500. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2512 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2512 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2512 may operate in accordance with other wireless protocols in other embodiments. The computing device 2500 may include an antenna 2522 to facilitate wireless communications and/or to receive other wireless communications (such as AM or FM radio transmissions).

In some embodiments, the communication chip 2512 may manage wired communications, such as electrical, optical, or any other suitable communication protocols (e.g., the Ethernet). As noted above, the communication chip 2512 may include multiple communication chips. For instance, a first communication chip 2512 may be dedicated to shorter-range wireless communications such as Wi-Fi or Bluetooth, and a second communication chip 2512 may be dedicated to longer-range wireless communications such as global positioning system (GPS), EDGE, GPRS, CDMA, WiMAX, LTE, EV-DO, or others. In some embodiments, a first communication chip 2512 may be dedicated to wireless communications, and a second communication chip 2512 may be dedicated to wired communications.

The computing device 2500 may include battery/power circuitry 2514. The battery/power circuitry 2514 may include one or more energy storage devices (e.g., batteries or capacitors) and/or circuitry for coupling components of the computing device 2500 to an energy source separate from the computing device 2500 (e.g., AC line power).

The computing device 2500 may include a display device 2506 (or corresponding interface circuitry, as discussed above). The display device 2506 may include any visual indicators, such as a heads-up display, a computer monitor, a projector, a touchscreen display, a liquid crystal display (LCD), a light-emitting diode display, or a flat panel display, for example.

The computing device 2500 may include an audio output device 2508 (or corresponding interface circuitry, as discussed above). The audio output device 2508 may include any device that generates an audible indicator, such as speakers, headsets, or earbuds, for example.

The computing device 2500 may include an audio input device 2518 (or corresponding interface circuitry, as discussed above). The audio input device 2518 may include any device that generates a signal representative of a sound, such as microphones, microphone arrays, or digital instruments (e.g., instruments having a musical instrument digital interface (MIDI) output).

The computing device 2500 may include a GPS device 2516 (or corresponding interface circuitry, as discussed above). The GPS device 2516 may be in communication with a satellite-based system and may receive a location of the computing device 2500, as known in the art.

The computing device 2500 may include another output device 2510 (or corresponding interface circuitry, as discussed above). Examples of the other output device 2510 may include an audio codec, a video codec, a printer, a wired or wireless transmitter for providing information to other devices, or an additional storage device.

The computing device 2500 may include another input device 2520 (or corresponding interface circuitry, as discussed above). Examples of the other input device 2520 may include an accelerometer, a gyroscope, a compass, an image capture device, a keyboard, a cursor control device such as a mouse, a stylus, a touchpad, a bar code reader, a Quick Response code reader, any sensor, or a radio frequency identification (RFID) reader.

The computing device 2500 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2500 may be any other electronic device that processes data.

The following paragraphs provide additional examples of the embodiments disclosed herein.

Example 1 provides one or more non-transitory computer-readable media storing instructions executable to perform operations, the operations including determining a first transformation matrix and a second transformation matrix for an attention layer of a transformer model, the transformer model trained to perform a task, the attention layer having a query weight matrix, a key weight matrix, and a value weight matrix; generating canonicalized weights based on the first transformation matrix and the second transformation matrix, in which generating the canonicalized weights includes transforming the query weight matrix and the key weight matrix based on the first transformation matrix, and transforming the value weight matrix based on the second transformation matrix; producing a canonicalized transformer model by modifying the attention layer with the canonicalized weights; and executing the canonicalized transformer model to perform the task.

Example 2 provides the one or more non-transitory computer-readable media of example 1, in which executing the canonicalized transformer model includes executing matrix multiplication operations of the modified attention layer to compute canonicalized key-value data; storing a first portion of the canonicalized key-value data in a first key-value cache; and storing a second portion of the canonicalized key-value data in a second key-value cache, in which the first key-value cache provides faster access to data than the second key-value cache.

Example 3 provides the one or more non-transitory computer-readable media of example 2, in which the operations further include determining a size of a sliding hot window, the size of the sliding hot window indicating a number of hot window tokens, in which the first portion of the canonicalized key-value data includes keys and values corresponding to the hot window tokens.

Example 4 provides the one or more non-transitory computer-readable media of example 2 or 3, in which executing the canonicalized transformer model further includes compressing the second portion of the canonicalized key-value data so that the second portion of the canonicalized key-value data in the second key-value cache has a lower data precision than the first portion of the canonicalized key-value data in the first key-value cache.

Example 5 provides the one or more non-transitory computer-readable media of example 4, in which compressing the second portion of the canonicalized key-value data includes compressing the second portion of the canonicalized key-value data through entropy encoding.

Example 6 provides the one or more non-transitory computer-readable media of any one of examples 1-5, in which generating the canonicalized weights further includes reducing a dimension of the key weight matrix or value weight matrix, in which the canonicalized weights include a canonicalized key weight matrix or a canonicalized value weight matrix, the canonicalized key weight matrix or the canonicalized value weight matrix having the reduced dimension.

Example 7 provides the one or more non-transitory computer-readable media of example 6, in which reducing the dimension of the key weight matrix or value weight matrix includes determining the reduced dimension of the key weight matrix or value weight matrix based on an available memory bandwidth of a hardware device executing the canonicalized transformer model or a requirement on an accuracy of the canonicalized transformer model.

Example 8 provides the one or more non-transitory computer-readable media of any one of examples 1-7, in which transforming the query weight matrix and the key weight matrix includes transforming the query weight matrix by multiplying the query weight matrix by the first transformation matrix; and transforming the key weight matrix by multiplying the key weight matrix by an inverse of a transpose of the first transformation matrix.

Example 9 provides the one or more non-transitory computer-readable media of any one of examples 1-8, in which generating the canonicalized weights further includes transforming an output weight matrix of the attention layer based on the second transformation matrix.

Example 10 provides the one or more non-transitory computer-readable media of example 9, in which the value weight matrix is transformed using the second transformation matrix, in which the output weight matrix is transformed using an inverse of the second transformation matrix.

Example 11 provides a method, including determining a first transformation matrix and a second transformation matrix for an attention layer of a transformer model, the transformer model trained to perform a task, the attention layer having a query weight matrix, a key weight matrix, and a value weight matrix; generating canonicalized weights based on the first transformation matrix and the second transformation matrix, in which generating the canonicalized weights includes transforming the query weight matrix and the key weight matrix based on the first transformation matrix, and transforming the value weight matrix based on the second transformation matrix; producing a canonicalized transformer model by modifying the attention layer with the canonicalized weights; and executing the canonicalized transformer model to perform the task.

Example 12 provides the method of example 11, in which executing the canonicalized transformer model includes executing matrix multiplication operations of the modified attention layer to compute canonicalized key-value data; storing a first portion of the canonicalized key-value data in a first key-value cache; and storing a second portion of the canonicalized key-value data in a second key-value cache, in which the first key-value cache provides faster access to data than the second key-value cache.

Example 13 provides the method of example 12, further including determining a size of a sliding hot window, the size of the sliding hot window indicating a number of hot window tokens, in which the first portion of the canonicalized key-value data includes keys and values corresponding to the hot window tokens.

Example 14 provides the method of example 12 or 13, in which executing the canonicalized transformer model further includes compressing the second portion of the canonicalized key-value data so that the second portion of the canonicalized key-value data in the second key-value cache has a lower data precision than the first portion of the canonicalized key-value data in the first key-value cache.

Example 15 provides the method of example 14, in which compressing the second portion of the canonicalized key-value data includes compressing the second portion of the canonicalized key-value data through entropy encoding.

Example 16 provides the method of any one of examples 11-15, in which generating the canonicalized weights further includes reducing a dimension of the key weight matrix or value weight matrix, in which the canonicalized weights include a canonicalized key weight matrix or a canonicalized value weight matrix, the canonicalized key weight matrix or the canonicalized value weight matrix having the reduced dimension.

Example 17 provides the method of example 16, in which reducing the dimension of the key weight matrix or value weight matrix includes determining the reduced dimension of the key weight matrix or value weight matrix based on an available memory bandwidth of a hardware device executing the canonicalized transformer model or a requirement on an accuracy of the canonicalized transformer model.

Example 18 provides the method of any one of examples 11-17, in which transforming the query weight matrix and the key weight matrix includes transforming the query weight matrix by multiplying the query weight matrix by the first transformation matrix; and transforming the key weight matrix by multiplying the key weight matrix by an inverse of a transpose of the first transformation matrix.

Example 19 provides the method of any one of examples 11-18, in which generating the canonicalized weights further includes transforming an output weight matrix of the attention layer based on the second transformation matrix.

Example 20 provides the method of example 19, in which the value weight matrix is transformed using the second transformation matrix, in which the output weight matrix is transformed using an inverse of the second transformation matrix.

Example 21 provides an apparatus, including a computer processor for executing computer program instructions; and a non-transitory computer-readable memory storing computer program instructions executable by the computer processor to perform operations, the operations including determining a first transformation matrix and a second transformation matrix for an attention layer of a transformer model, the transformer model trained to perform a task, the attention layer having a query weight matrix, a key weight matrix, and a value weight matrix, generating canonicalized weights based on the first transformation matrix and the second transformation matrix, in which generating the canonicalized weights includes transforming the query weight matrix and the key weight matrix based on the first transformation matrix, and transforming the value weight matrix based on the second transformation matrix, producing a canonicalized transformer model by modifying the attention layer with the canonicalized weights, and executing the canonicalized transformer model to perform the task.

Example 22 provides the apparatus of example 21, in which executing the canonicalized transformer model includes executing matrix multiplication operations of the modified attention layer to compute canonicalized key-value data; storing a first portion of the canonicalized key-value data in a first key-value cache; and storing a second portion of the canonicalized key-value data in a second key-value cache, in which the first key-value cache provides faster access to data than the second key-value cache.

Example 23 provides the apparatus of example 22, in which executing the canonicalized transformer model further includes compressing the second portion of the canonicalized key-value data so that the second portion of the canonicalized key-value data in the second key-value cache has a lower data precision than the first portion of the canonicalized key-value data in the first key-value cache.

Example 24 provides the apparatus of any one of examples 21-23, in which generating the canonicalized weights further includes reducing a dimension of the key weight matrix or value weight matrix, in which the canonicalized weights include a canonicalized key weight matrix or a canonicalized value weight matrix, the canonicalized key weight matrix or the canonicalized value weight matrix having the reduced dimension.

Example 25 provides the apparatus of any one of examples 21-24, in which transforming the query weight matrix and the key weight matrix includes transforming the query weight matrix by multiplying the query weight matrix by the first transformation matrix; and transforming the key weight matrix by multiplying the key weight matrix by an inverse of a transpose of the first transformation matrix.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. One or more non-transitory computer-readable media storing instructions executable to perform operations, the operations comprising:
determining a first transformation matrix and a second transformation matrix for an attention layer of a transformer model, the transformer model trained to perform a task, the attention layer having a query weight matrix, a key weight matrix, and a value weight matrix;
generating canonicalized weights based on the first transformation matrix and the second transformation matrix, wherein generating the canonicalized weights comprises:
transforming the query weight matrix and the key weight matrix based on the first transformation matrix, and
transforming the value weight matrix based on the second transformation matrix;
producing a canonicalized transformer model by modifying the attention layer with the canonicalized weights; and
executing the canonicalized transformer model to perform the task.

2. The one or more non-transitory computer-readable media of claim 1, wherein executing the canonicalized transformer model comprises:
executing matrix multiplication operations of the modified attention layer to compute canonicalized key-value data;
storing a first portion of the canonicalized key-value data in a first key-value cache; and
storing a second portion of the canonicalized key-value data in a second key-value cache,
wherein the first key-value cache provides faster access to data than the second key-value cache.

3. The one or more non-transitory computer-readable media of claim 2, wherein the operations further comprise:
determining a size of a sliding hot window, the size of the sliding hot window indicating a number of hot window tokens,
wherein the first portion of the canonicalized key-value data comprises keys and values corresponding to the hot window tokens.

4. The one or more non-transitory computer-readable media of claim 2, wherein executing the canonicalized transformer model further comprises:
compressing the second portion of the canonicalized key-value data so that the second portion of the canonicalized key-value data in the second key-value cache has a lower data precision than the first portion of the canonicalized key-value data in the first key-value cache.

5. The one or more non-transitory computer-readable media of claim 4, wherein compressing the second portion of the canonicalized key-value data comprises:
compressing the second portion of the canonicalized key-value data through entropy encoding.

6. The one or more non-transitory computer-readable media of claim 1, wherein generating the canonicalized weights further comprises:
reducing a dimension of the key weight matrix or value weight matrix,
wherein the canonicalized weights comprise a canonicalized key weight matrix or a canonicalized value weight matrix, the canonicalized key weight matrix or the canonicalized value weight matrix having the reduced dimension.

7. The one or more non-transitory computer-readable media of claim 6, wherein reducing the dimension of the key weight matrix or value weight matrix comprises:
determining the reduced dimension of the key weight matrix or value weight matrix based on an available memory bandwidth of a hardware device executing the canonicalized transformer model or a requirement on an accuracy of the canonicalized transformer model.

8. The one or more non-transitory computer-readable media of claim 1, wherein transforming the query weight matrix and the key weight matrix comprises:
transforming the query weight matrix by multiplying the query weight matrix by the first transformation matrix; and
transforming the key weight matrix by multiplying the key weight matrix by an inverse of a transpose of the first transformation matrix.

9. The one or more non-transitory computer-readable media of claim 1, wherein generating the canonicalized weights further comprises transforming an output weight matrix of the attention layer based on the second transformation matrix.

10. The one or more non-transitory computer-readable media of claim 9, wherein the value weight matrix is transformed using the second transformation matrix, wherein the output weight matrix is transformed using an inverse of the second transformation matrix.

11. A method, comprising:
determining a first transformation matrix and a second transformation matrix for an attention layer of a transformer model, the transformer model trained to perform a task, the attention layer having a query weight matrix, a key weight matrix, and a value weight matrix;
generating canonicalized weights based on the first transformation matrix and the second transformation matrix, wherein generating the canonicalized weights comprises:
transforming the query weight matrix and the key weight matrix based on the first transformation matrix, and
transforming the value weight matrix based on the second transformation matrix;
producing a canonicalized transformer model by modifying the attention layer with the canonicalized weights; and
executing the canonicalized transformer model to perform the task.

12. The method of claim 11, wherein executing the canonicalized transformer model comprises:
executing matrix multiplication operations of the modified attention layer to compute canonicalized key-value data;
storing a first portion of the canonicalized key-value data in a first key-value cache; and
storing a second portion of the canonicalized key-value data in a second key-value cache,
wherein the first key-value cache provides faster access to data than the second key-value cache.

13. The method of claim 12, further comprising:
determining a size of a sliding hot window, the size of the sliding hot window indicating a number of hot window tokens,
wherein the first portion of the canonicalized key-value data comprises keys and values corresponding to the hot window tokens.

14. The method of claim 12, wherein executing the canonicalized transformer model further comprises:
compressing the second portion of the canonicalized key-value data so that the second portion of the canonicalized key-value data in the second key-value cache has a lower data precision than the first portion of the canonicalized key-value data in the first key-value cache.

15. The method of claim 11, wherein generating the canonicalized weights further comprises:
reducing a dimension of the key weight matrix or value weight matrix,
wherein the canonicalized weights comprise a canonicalized key weight matrix or a canonicalized value weight matrix, the canonicalized key weight matrix or the canonicalized value weight matrix having the reduced dimension.

16. The method of claim 11, wherein transforming the query weight matrix and the key weight matrix comprises:
transforming the query weight matrix by multiplying the query weight matrix by the first transformation matrix; and
transforming the key weight matrix by multiplying the key weight matrix by an inverse of a transpose of the first transformation matrix.

17. The method of claim 11, wherein generating the canonicalized weights further comprises transforming an output weight matrix of the attention layer, wherein the value weight matrix is transformed using the second transformation matrix, wherein the output weight matrix is transformed using an inverse of the second transformation matrix.

18. An apparatus, comprising:
a computer processor for executing computer program instructions; and
a non-transitory computer-readable memory storing computer program instructions executable by the computer processor to perform operations, the operations comprising:
determining a first transformation matrix and a second transformation matrix for an attention layer of a transformer model, the transformer model trained to perform a task, the attention layer having a query weight matrix, a key weight matrix, and a value weight matrix,
generating canonicalized weights based on the first transformation matrix and the second transformation matrix, wherein generating the canonicalized weights comprises:
transforming the query weight matrix and the key weight matrix based on the first transformation matrix, and
transforming the value weight matrix based on the second transformation matrix,
producing a canonicalized transformer model by modifying the attention layer with the canonicalized weights, and
executing the canonicalized transformer model to perform the task.

19. The apparatus of claim 18, wherein executing the canonicalized transformer model comprises:
executing matrix multiplication operations of the modified attention layer to compute canonicalized key-value data;
storing a first portion of the canonicalized key-value data in a first key-value cache; and
storing a second portion of the canonicalized key-value data in a second key-value cache,
wherein the first key-value cache provides faster access to data than the second key-value cache.

20. The apparatus of claim 18, wherein generating the canonicalized weights further comprises:
reducing a dimension of the key weight matrix or value weight matrix,
wherein the canonicalized weights comprise a canonicalized key weight matrix or a canonicalized value weight matrix, the canonicalized key weight matrix or the canonicalized value weight matrix having the reduced dimension.
